(19) United States
(12) Patent Application Publication
(10) Pub. No.: US 2023/0195415 A1
(43) Pub. Date: Jun. 22, 2023

(54) FIXED BINARY ADDER WITH SMALL AREA AND METHOD OF DESIGNING THE SAME

(71) Applicant: SK hynix Inc., Icheon-si Gyeonggi-do (KR)

(72) Inventor: Seong Ju LEE, Icheon-si Gyeonggi-do (KR)

(73) Assignee: SK hynix Inc., Icheon-si Gyeonggi-do (KR)

(21) Appl. No.: 17/831,093

(22) Filed: Jun. 2, 2022

(30) Foreign Application Priority Data
Dec. 21, 2021 (KR) 10-2021-0184319

(51) Int. Cl. G06F 7/501; G06F 7/499; H03K 19/20

(52) U.S. Cl. CPC G06F 7/501; G06F 7/49942; H03K 19/20

(57) ABSTRACT

A fixed binary adder adds an “N”-bit second operand to a first operand having an “N”-bit fixed value (N=2^{M}, M is a natural number) to generate “N+1”-bit output data. The fixed binary adder includes a plurality of transfer logic stages each configured with at least one logic gate, and a summation addition logic configured to generate the “N+1”-bit output data by using the “N”-bit second operand and transfer data that is generated through the plurality of transfer logic stages. The logic gate is configured with one of an AND gate, an OR gate, and a buffer gate.

### CROSS-REFERENCE TO RELATED APPLICATIONS

The present application claims priority under 35 U.S.C. 119(a) to Korean Application No. 10-2021-0184319, filed on Dec. 21, 2021, which is incorporated herein by reference in its entirety.

### BACKGROUND

### 1. Technical Field

Various embodiments of the present disclosure generally relates to a fixed binary adder, and more particularly, to a fixed binary adder with a small area and a method of designing the same.

### 2. Related Art

In general, an addition process is one of the most important arithmetic operations frequently performed in a data processing apparatus. A problem associated with generating a high-speed addition circuit is that the carry-out of a lower bit is used in the arithmetic operation for the next bit. That is, after calculating one bit, the next bit should be sequentially calculated using the result. In this way, parallel processing is impossible, and accordingly, the addition operation tends to be very slow. In order to improve this problem, an addition device having a prefix structure that introduces the concepts of a logic (carry generation; G) for generating a carry from a corresponding bit and a logic (carry propagation; P) for transferring a carry of the corresponding bit is widely used. In particular, various types of tree adders that employ the prefix structure and allow parallel calculations to be performed have been proposed. The most well-known tree adder is the Kogge-Stone adder.

Meanwhile, in addition to the addition operation of adding two operands, the demand for a fixed binary adder in which one operand has a fixed value has recently increased. The fixed addition operator may be employed, for example, for operations such as normalization processing, round processing, two's complement, bias addition, and the like in an artificial neural network operation. Since the fixed addition operator has a structure in which only one operand is input instead of two operands, circuit area and power consumption can be reduced compared to the conventional adder.

### SUMMARY

A fixed binary adder according to an embodiment of the present disclosure may add an “N”-bit second operand to a first operand having an “N”-bit fixed value (N=2M, M is a natural number) and generate “N+1”-bit output data. The fixed binary adder may include a plurality of transfer logic stages and a summation addition logic configured to generate the “N+1”-bit output data by using the “N”-bit second operand and transfer data that is generated through the plurality of transfer logic stages. Each of the plurality of transfer logic stages may be configured with at least one of logic gate. The logic gate may be configured with one of an AND gate, an OR gate, and a buffer gate.

A method of designing a fixed binary adder according to an embodiment of the present disclosure may be a method of adding an “N”-bit second operand to a first operand having an “N”-bit fixed value (N=2^{M}, M is a natural number) to generate “N+1” bit output data and may include generating a plurality of transfer logic stages, each of the plurality of transfer logic stages being configured with logic gates, each of the logic gates being one of an AND gate, an OR gate, and a buffer, and generating a summation logic stage configured to generate the “N+1”-bit output data by using the “N”-bit second operand and transfer data that is generated through the plurality of transfer logic stages.

### BRIEF DESCRIPTION OF THE DRAWINGS

Certain features of the disclosed technology are shown by various embodiments with reference to the attached drawings.

FIG. 1 is a block diagram illustrating a fixed binary adder according to the present disclosure.

FIG. 2 is a block diagram illustrating an example of a configuration of a fixed binary adder according to the present disclosure.

FIG. 3 is a diagram illustrating an example of a first transfer logic stage of the fixed binary adder of FIG. 2.

FIG. 4 is a diagram illustrating an example of a second transfer logic stage of the fixed binary adder of FIG. 2.

FIG. 5 is a diagram illustrating an example of a K^{th} transfer logic stage of the fixed binary adder of FIG. 2.

FIG. 6 is a diagram illustrating an example of a M^{th} transfer logic stage of the fixed binary adder of FIG. 2.

FIG. 7 is a diagram illustrating an example of a summation logic stage of the fixed binary adder of FIG. 2.

FIG. 8 is a diagram illustrating a “+1” fixed binary adder according to an example of the present disclosure.

FIG. 9 is a diagram illustrating an addition operation of the “+1” fixed binary adder of FIG. 8.

FIG. 10 is a diagram illustrating a “+13” fixed binary adder according to another example of the present disclosure.

FIG. 11 is a diagram illustrating an addition operation of the “+13” fixed binary adder of FIG. 10.

FIG. 12 is a diagram illustrating a “−3” fixed binary adder according to another example of the present disclosure.

FIG. 13 is a diagram illustrating an example of an addition operation of the “−3” fixed binary adder of FIG. 12.

FIG. 14 is a diagram illustrating another example of an addition operation of the “−3” fixed binary adder of FIG. 12.

FIG. 15 is a diagram illustrating a method of designing a fixed binary adder according to an example of the present disclosure.

FIG. 16 is a diagram illustrating a method of selecting a logic gate in each of transfer logic stages in a method of designing a fixed binary adder according to an example of the present disclosure.

FIGS. 17 to 20 are diagrams illustrating a method of configuring a first transfer logic stage in a method of designing a fixed binary adder according to an example of the present disclosure.

FIGS. 21 to 24 are diagrams illustrating a method of configuring a second transfer logic stage in a method of designing a fixed binary adder according to an example of the present disclosure.

FIGS. 25 to 28 are diagrams illustrating a method of configuring a M^{th} transfer logic stage in a method of designing a fixed binary adder according to an example of the present disclosure.

FIG. 29 is a diagram illustrating a method of configuring an addition logic stage in a method of designing a fixed binary adder according to an example of the present disclosure.

FIGS. 30 to 33 are diagrams illustrating a method of designing the “+13” fixed binary adder of FIG. 10 according to an example of the present disclosure.

### DETAILED DESCRIPTION

In the following description of embodiments, it will be understood that the terms “first” and “second” are intended to identify elements, but not used to define a particular number or sequence of elements. In addition, when an element is referred to as being located “on,” “over,” “above,” “under,” or “beneath” another element, it is intended to mean relative positional relationship, but not used to limit certain cases for which the element directly contacts the other element, or at least one intervening element is present between the two elements. Accordingly, the terms such as “on,” “over,” “above,” “under,” “beneath,” “below,” and the like that are used herein are for the purpose of describing particular embodiments only and are not intended to limit the scope of the present disclosure.

Further, when an element is referred to as being “connected” or “coupled” to another element, the element may be electrically or mechanically connected or coupled to the other element directly or may be electrically or mechanically connected or coupled to the other element indirectly with one or more additional elements between the two elements. Moreover, when a parameter is referred to as being “predetermined,” it may be intended to mean that a value of the parameter is determined in advance of when the parameter is used in a process or an algorithm. The value of the parameter may be set when the process or the algorithm starts or may be set during a period in which the process or the algorithm is executed.

A logic “high” level and a logic “low” level may be used to describe logic levels of electric signals. A signal having a logic “high” level may be distinguished from a signal having a logic “low” level. For example, when a signal having a first voltage corresponds to a signal having a logic “high” level, a signal having a second voltage may correspond to a signal having a logic “low” level. In an embodiment, the logic “high” level may be set as a voltage level which is higher than a voltage level of the logic “low” level. Meanwhile, logic levels of signals may be set to be different or opposite according to embodiment. For example, a certain signal having a logic “high” level in one embodiment may be set to have a logic “low” level in another embodiment.

Various embodiments of the present disclosure will be described hereinafter in detail with reference to the accompanying drawings. However, the embodiments described herein are for illustrative purposes only and are not intended to limit the scope of the present disclosure.

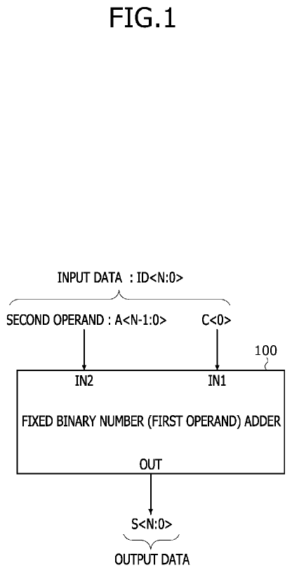

FIG. 1 is a block diagram illustrating a fixed binary adder 100 according to the present disclosure. Referring to FIG. 1, the fixed binary adder 100 may add an “N”-bit second operand A<N−1:0> to a first operand having an “N”-bit fixed binary value to generate “N+1”-bit output data S<N:0>. When “M” is a natural number, “N” may be defined as “2^{M}”, and this may be applied equally to the following various examples. The fixed binary adder 100 may include a first input terminal IN1, a second input terminal IN2, and an output terminal OUT. The fixed binary adder 100 may receive 1-bit carry-in data C<0> through the first input terminal IN1. The carry-in data C<0> may have a fixed value of “0”. The fixed binary adder 100 may receive an “N”-bit second operand A<N−1:0> through the second input terminal IN2. The carry-in data C<0> and the second operand A<N−1:0> may constitute input data ID<N:0>. That is, “N+1”-bit input data ID<N:0> may be input through the first input terminal IN1 and the second input terminal IN2. “N+1”-bit output data S<N:0> that is generated in the fixed binary adder 100 may be output through the output terminal OUT. A most significant bit MSB S<N> of the output data S<N:0> may constitute 1-bit carry-out data that is generated by adding the first operand and the second operand A<N−1:0>. The remaining “N”^{th} to first bits S<N−1:0>, except for the most significant bit S<N>, among the bits of the output data S<N:0>, may constitute “N”-bit summation data that is generated by adding the first operand and the second operand A<N−1:0>.

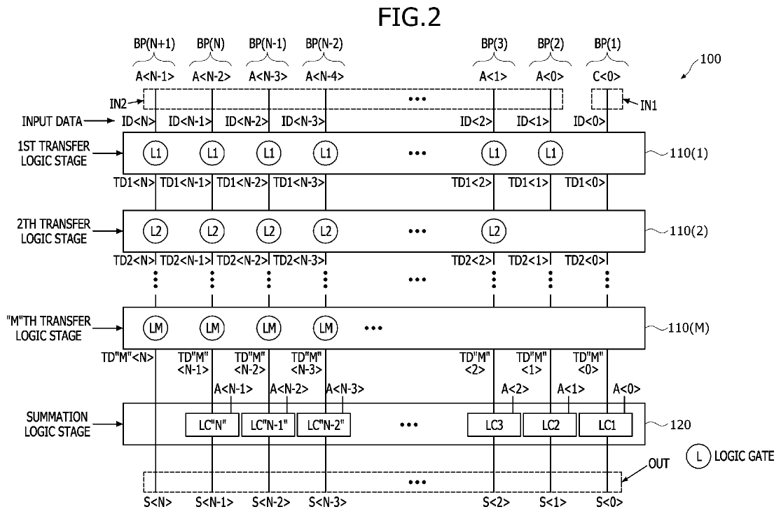

FIG. 2 is a block diagram illustrating an example of a configuration of a fixed binary adder 100 according to the present disclosure. Hereinafter, a case in which “N+1”-bit output data S<N:0> is generated by adding an N-bit second operand A<N−1:0> to a first operand having an “N”-bit fixed binary value will be taken as an example. Referring to FIG. 2, the fixed binary adder 100 may include a first input terminal IN1, a second input terminal IN2, and an output terminal OUT. The fixed binary adder 100 may receive 1-bit carry-in data C<0> through the first input terminal IN1. The fixed binary adder 100 may receive an “N”-bit second operand A<N−1:0> through the second input terminal IN2. The fixed binary adder 100 may output “N+1”-bit output data S<N:0> through the output terminal OUT. The “N”-bit second operand A<N−1:0> and the 1-bit carry-in data C<0> may constitute “N+1”-bit input data ID<N:0>. The 1-bit carry-in data C<0> may constitute a least significant (first) bit (LSB) ID<0> of the input data ID<N:0>. The “N”-bit second operand A<N−1:0> may constitute “N+1”^{th} to second bits of the input data ID<N:0>. Accordingly, a least significant (first) bit A<0> of the second operand A<N−1:0> may be input to the fixed binary adder 100 as a second bit ID<1> of the input data ID<N:0>. A second bit A<1> of the second operand A<N−1:0> may be input to the fixed binary adder 100 as a third bit ID<2> of the input data ID<N:0>. “N−1”^{th} to third bits A<N−2:2> of the second operand A<N−1:0> may be input to the fixed binary adder 100 as “N”^{th} to fourth bits ID<N−1:3> of the input data ID<N:0>, respectively, in the same manner. A most significant (“N”^{th}) bit A<N−1> of the second operand A<N−1:0> may be input to the fixed binary adder 100 as a most significant (“N+1”^{th}) bit ID<N> of the input data ID<N:0>.

The fixed binary adder 100 may include M transfer logic stages 110(1)-110(M) and one summation logic stage 120. Each of the transfer logic stages 110(1)-110(M) and the summation logic stage 120 may have “N+1” bit positions BP(N+1)-BP(1) corresponding to the “N+1”-bit input data ID<N:0>. The transfer logic stages 110(1)-110(M) and the summation logic stage 120 may constitute a tree adder structure that is dependent on each other. The first transfer logic stage 110(1) may directly receive the input data ID<N:0> that is received through the first input terminal IN1 and the second input terminal IN2. The first transfer logic stage 110(1) may output “N+1”-bit first transfer data TD1<N:0> and provide the generated “N+1”-bit first transfer data TD1<N:0> to the second transfer logic stage 110(2). Each of the second to “M−1”^{th} transfer logic stages 110(2)-110(M−1) may receive the transfer data that is output from upper transfer logic stage as input data. The transfer data that is output from each of the second to “M−1”^{th} transfer logic stages 110(2)-110(M−1) may be provided as input data of each of the lower transfer logic stages. The transfer data TD“M”<N:0> that is output from the “M”^{th} transfer logic stage 110(M) may be provided as the input data of the summation logic stage 120.

Each of the first to “M”^{th} transfer logic stages 110(1)-110(M) of the fixed binary adder 100 may include a plurality of transfer logic gates Ls. Each of the transfer logic gates Ls may include one of an AND gate, an OR gate, and a buffer gate. Each of the transfer logic stages 110(1)-110(M) may include a different number of transfer logic gates Ls. The first transfer logic stage 110(1) may include more transfer logic gates Ls than each of the other transfer logic stages 110(2)-110(M), the second transfer logic stage 110(2) may include more transfer logic gates Ls than each of the transfer logic stages 110(3)-110(M), and so on. Therefore, the “M”^{th} transfer logic stage 110(M) may include the least number of transfer logic gates Ls out of all of the transfer logic stages 110(1)-110(M). When “K” is a natural number of 1 or more and “M” or less, the “K”^{th} transfer logic stage may have N+1−2^{K-1} logic gates. Accordingly, the first transfer logic stage 110(1) may include “N” logic gates L1s. The second transfer logic stage 110(2) may include “N−1” logic gates L2s. The “M”^{th} transfer logic stage 110(M) may include “N+1−2^{M-1}” logic gates LMs.

In the transfer logic stages 110(1)-110(M), the logic gate L might not be disposed at the first bit position BP1. However, when considering all the transfer logic stages 110(1)-110(M), at least one logic gate L may be disposed at each of the “N+1”^{th} to second bit positions BP(N+1)-BP (2). In the case of the “K”^{th} transfer logic stage, N+1−^{2K-1} logic gates may be disposed at “N+1^{th}−“2^{K-1}+1”^{th} bit positions BP(N+1)-BP(2^{K-1}+1). As shown in FIG. 2, “N” logic gates L1s of the first transfer logic stage 110(1) may be disposed at “N+1”^{th} to second bit positions BP(N+1)-BP(2). The “N−1” logic gates L2s of the second transfer logic stage 110(2) may be disposed at “N+1”^{th} to third bit positions BP(N+1)-BP(3). Although fully not illustrated, “N+1-2^{M-1}” logic gates LMs of the “M”^{th} transfer logic stage 110(M) may be disposed at “N+1”^{th} to “2^{M-1}+1”^{th} bit positions BP(N+1)-BP(2^{M-1}+1).

The transfer data TD<N:0> that is output from the upper transfer logic stage, among the transfer logic stages 110(1)-110(M), may be transmitted to the logic gate L in the lower transfer logic stage while maintaining the same bit position. For example, the “N+1”^{th} bit TD1<N> of the first transfer data TD1<N:0> that is output from the “N+1”^{th} bit position BP(N+1) of the first transfer logic stage 110(1) may be transmitted to the logic gate L in the “N+1”^{th} bit position BP(N+1) of the second transfer logic stage 110(2). The “N+1”^{th} bit TD2<N> of the second transfer data TD2<N:0> that is output from the “N+1”^{th} bit position BP(N+1) of the second transfer logic stage 110(2) may be transferred to the logic gate L in the “N+1”^{th} bit position BP(N+1) of the third transfer logic stage (not illustrated). The “N+1”^{th} bit TD“M”<N> of the “M”^{th} transfer data TD“M”<N:0> that is output from the “N+1”^{th} bit position BP(N+1) of the “M”^{th} transfer logic stage 110(M) may be transferred to the logic gate L in the “N+1”^{th} bit position BP(N+1) of the summation logic stage 120. When a logic gate L is absent at a bit position of a transfer logic stage, among the transfer logic stages 110(1)-110(M), the transfer data (or input data with regard to the first bit position BP(1) of the first transfer logic stage 110(1)) may be received and output as the subsequent transfer data by said transfer logic stage. For example, in the second bit position BP(2) of the second transfer logic stage 110(2), the second bit TD1<1> of the first transfer data TD1<N:0> that is transmitted from the second bit position BP(2) of the first transfer logic stage 110(1) may be output as the second bit TD 2<1> of the second transfer data TD2<N:0>.

The summation logic stage 120 may receive “N+1”-bit “M”^{th} transfer data TD“M”<N:0> that is output from the lowest transfer logic stage, that is, the “M”^{th} transfer logic stage 110(M), among the transfer logic stages 110(1)-110(M). In addition, the summation logic stage 120 may receive the “N”-bit second operand A<N−1:0>. The summation logic stage 120 may include “N” logic circuits LC“N”-LC1. Although not shown in the drawing, each of the logic circuits LC“N”-LC1 may be configured only with an exclusive OR gate or may be configured with an XOR gate and a NOT gate (or inverter). The “N” logic circuits LC“N”-LC1 may be disposed at the remaining “N”^{th} to first bit positions BP(N)-BP(1), except for the most significant bit position, “N+1”^{th} bit position BP(N+1), among the “N+1”^{th} to first bit positions BP(N+1)-BP(1) of the summation logic stage 120. At the “N+1”^{th} bit position BP(N+1) of the summation logic stage 120, the “N+1”^{th} bit TD“M”<N> of the “M”^{th} transfer data TD“M”<N:0> that is transmitted from the “N+1”^{th} bit position BP(N+1) of the “M”^{th} transfer logic stage 110(M) may be output as a most significant bit of the “N+1”-bit output data S<N:0>, that is, the “N+1”^{th} bit S<N>. The most significant bit of the “N+1”-bit output data S<N:0>, that is, the “N+1”^{th} bit S<N> may be used as the carry-out data.

The logic circuit LC“N” that is disposed at the “N”^{th} bit position BP(N) of the summation logic stage 120 may receive the “N”^{th} bit TD“M”<N−1> of the “M”^{th} transfer data TD“M”<N−1:0> that is transmitted from the “M”^{th} transfer logic stage 110(M) and the “N”^{th} bit A<N−1> of the second operand A<N−1:0> to generate and output “N”^{th} bit S<N−1> of the output data S<N:0>. The logic circuit LC“N−1” that is disposed at the “N−1”^{th} bit position BP(N−1) of the summation logic stage 120 may receive the “N−1”^{th} bit TD“M”<N−2> of the “M”^{th} transfer data TD“M”<N−1:0> that is transmitted from the “M”^{th} transfer logic stage 110(M) and the “N−1”^{th} bit A<N−2> of the second operand A<N−1:0> to generate and output “N−1”^{th} bit S<N−2> of the output data S<N:0>. The logic circuit LC“N−2” that is disposed at the “N−2”^{th} bit position BP(N−2) of the summation logic stage 120 may receive the “N−2”^{th} bit TD“M”<N−3> of the “M”^{th} transfer data TD“M”<N−1:0> that is transmitted from the “M”^{th} transfer logic stage 110(M) and the “N−2”^{th} bit A<N−3> of the second operand A<N−1:0> to generate and output “N−2”^{th} bit S<N−3> of the output data S<N:0>. The logic circuit LC3 that is disposed at the third bit position BP(3) of the summation logic stage 120 may receive the third bit TD“M”<2> of the “M”^{th} transfer data TD“M”<N−1:0> that is transmitted from the “M”^{th} transfer logic stage 110(M) and the third bit A<2> of the second operand A<N−1:0> to generate and output third bit S<2> of the output data S<N:0>. The logic circuit LC2 that is disposed at the second bit position BP(2) of the summation logic stage 120 may receive the second bit TD“M”<1> of the “M”^{th} transfer data TD“M”<N−1:0> that is transmitted from the “M”^{th} transfer logic stage 110(M) and the second bit A<1> of the second operand A<N−1:0> to generate and output second bit S<1> of the output data S<N:0>. The logic circuit LC1 that is disposed at the first bit position BP(1) of the summation logic stage 120 may receive the first bit TD“M”<0> of the “M”^{th} transfer data TD“M”<N−1:0> that is transmitted from the “M”^{th} transfer logic stage 110(M) and the first bit A<0> of the second operand A<N−1:0> to generate and output first bit S<0> of the output data S<N:0>.

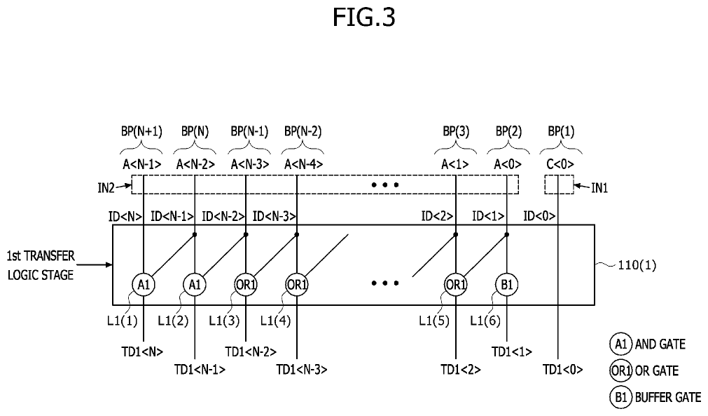

FIG. 3 is a diagram illustrating an example of the first transfer logic stage 110(1) of the fixed binary adder 100 of FIG. 2. Referring to FIG. 3, the first transfer logic stage 110(1) may have “N+1” bit positions BP(N+1)-BP(1). Each of the “N+1” bit positions BP(N+1)-BP(1) may correspond to each of the bits of the “N+1”-bit input data IN<N:0>. “N” logic gates may be disposed at the “N+1”^{th} to second bit positions BP(N+1)-BP(2), except for the first bit position BP(1), among the “N+1” bit positions BP(N+1)-BP(1). In FIG. 3, only six logic gates L1(1)-L1(6), among the “N” logic gates, are shown, and the remaining “N−6” logic gates are omitted. As shown in the drawings, AND gates (A1) L1(1) and L1(2) may be disposed at the “N+1”^{th} bit position BP(N+1) and the “N”^{th} bit position BP(N), respectively. OR gates (OR1) L1(3), L1(4), and L1(5) may be disposed at the “N−1”^{th} bit position BP(N−1), the “N−2”^{th} bit position BP(N−2), and the third bit position BP(3), respectively. A buffer gate (B1) L1(6) may be disposed at the second bit position BP(2). The type of the logic gates that are disposed at the “N+1”^{th} to third bit positions BP(N+1)-BP(3) may be determined by the first operand. At the second bit position BP(2), the buffer gate L1(2) may be fixedly disposed regardless of a value of the first operand. A logic gate might not be disposed at the first bit position BP(1).

The AND gates L1(1) and L1(2), the OR gates L1(3), L1(4), and L1(5), and the buffer gate L1(6) may each receive a bit, among the bits of the input data ID<N:0>, corresponding to the bit position BP at which the logic gate is disposed. The AND gates L1(1) and L1(2) and the OR gates L1(3), L1(4), and L1(5) may each receive a bit, among the bits of the input data ID<N:0>, corresponding to a bit position that is 1 bit lower than the bit position at which the logic gate is disposed. Specifically, the AND gate L1(1) that is disposed at the “N+1”^{th} bit position BP(N+1) may receive the “N+1”^{th} bit ID<N> and the “N”^{th} bit ID<N−1> of the input data ID<N:0>. The AND gate L1(2) that is disposed at the “N”^{th} bit position BP(N) may receive the “N”^{th} bit ID<N−1> and the “N−1”^{th} bit ID<N−2> of the input data ID<N:0>. The OR gate L1(3) that is disposed at the “N−1”^{th} bit position BP(N−1) may receive the “N−1”^{th} bit ID<N−2> and the “N−2”^{th} bit ID<N−3> of the input data ID<N:0>. The OR gate L1(4) that is disposed at the “N−2”^{th} bit position BP(N−2) may receive the “N−2”^{th} bit ID<N−3> and the “N−3”^{th} bit (not illustrated) of the input data ID<N:0>. The OR gate L1(5) that is disposed at the third bit position BP(3) may receive the third bit ID<2> and the second bit ID<1> of the input data ID<N:0>. The buffer gate L1(6) that is disposed at the second bit position BP(2) may receive the second bit ID<1> of the input data ID<N:0>.

The AND gate L1(1) that is disposed at the “N+1”^{th} bit position BP(N+1) may perform an AND operation on the “N+1”^{th} bit ID<N> and the “N”^{th} bit ID<N−1> of the input data ID<N:0> to generate and output the “N+1”^{th} bit TD1<N> of the first transfer data TD1<N:0>. The AND gate L1(2) that is disposed at the “N”^{th} bit position BP(N) may perform an AND operation on the “N”^{th} bit ID<N−1> and the “N−1”^{th} bit ID<N−2> of the input data ID<N:0> to generate and output the “N”^{th} bit TD1<N−1> of the first transfer data TD1<N:0>. The OR gate L1(3) that is disposed at the “N−1”^{th} bit position BP(N−1) may perform an OR operation on the “N−1”^{th} bit ID<N−2> and the “N−2”^{th} bit ID<N−3> of the input data ID<N:0> to generate and output the “N−1”^{th} bit TD1<N−2> of the first transfer data TD1<N:0>. The OR gate L1(4) that is disposed at the (N−2)^{th} bit position BP(N−2) may perform an OR operation on the (N−2)th bit ID<N−3> and the (N−3)th bit (not illustrated) of the input data ID<N:0> to generate and output the (N−2)th bit TD1<N−3> of the first transfer data TD1<N:0>. The OR gate L1(5) that is disposed at the third bit position BP(3) may perform an OR operation on the third bit ID<2> and the second bit ID<1> of the input data ID<N:0> to generate and output the third bit TD1<2> of the first transfer data TD1<N:0>. The buffer gate L1(6) that is disposed at the second bit position BP(2) may output the second bit ID<1> of the input data ID<N:0> as the second bit TD1<1> of the first transfer data TD1<N:0>. At the first bit position BP (1), the first bit ID<0> of the input data ID<N:0> may become the first bit TD1<0> of the first transfer data TD1<N:0>.

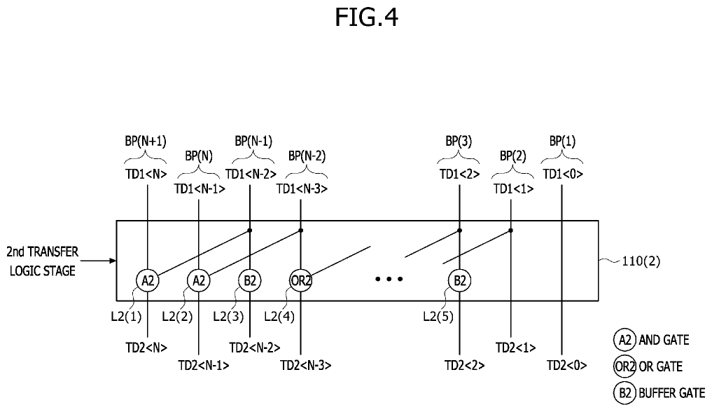

FIG. 4 is a diagram illustrating an example of the second transfer logic stage 110(2) of the fixed binary adder 100 of FIG. 2. Referring to FIG. 4, the second transfer logic stage 110(2) may also have “N+1” bit positions BP(N+1)-BP(1) like the first transfer logic stage 110(1). Each of the “N+1” bit positions BP(N+1)-BP(1) may correspond to each of the bits of the “N+1”-bit first transfer data TD1<N:0> transmitted from the first transfer logic stage 110(1). “N−1” logic gates may be disposed at the “N+1”^{th} to third bit positions BP(N+1)-BP(3), except for the first and second bit positions BP(1) and BP(2), among the “N+1” bit positions BP(N+1)-BP (1). In FIG. 4, only five logic gates L1(1)-L1(5), among the “N−1” logic gates, are shown, and the remaining “N−6” logic gates are omitted. As shown in the drawings, AND gates (A2) L1(1) and L1(2) may be disposed at the “N+1”^{th} bit position BP(N+1) and the “N”^{th} bit position BP(N), respectively. Buffer gates (B2) L2(3) and L2(5) may be disposed at the “N−1”^{th} bit position BP(N−1) and the third bit position BP(3), respectively. An OR gate (OR2) L1(4) may be disposed at the “N−2”^{th} bit position BP(N−2). At the third bit position BP(3), the buffer gate L1(5) may be fixedly disposed regardless of a value of the first operand. A logic gate might not be disposed at the second bit position BP(2) and the first bit position BP(1). The type of the logic gates that are disposed at the “N+1”^{th} to third bit positions BP(N+1)-BP(3) may be determined by the value of the first operand.

The AND gates L2(1) and L2(2), the buffer gates L2(3) and L2(5), and the OR gate L2(4) may each receive a bit, among the bits of the first transfer data TD1<N:0>, corresponding to the bit position BP at which the logic gate is disposed from the first transfer logic stage 110(1). The AND gates L2(1) and L1(2) and the OR gate L2(4) may each receive a bit, among the bits of the first transfer data TD1<N:0>, the bit being 2 bits lower than the bit position at which the logic gate is disposed. Specifically, the AND gate L2(1) that is disposed at the “N+1”^{th} bit position BP(N+1) may receive the “N+1”^{th} bit TD1<N> and the “N−1”^{th} bit TD1<N−2> of the first transfer data TD1<N:0>. The AND gate L2(2) that is disposed at the “N”^{th} bit position BP(N) may receive the “N”^{th} bit TD1<N−1> and the “N−2”^{th} bit TD1<N−3> of the first transfer data TD1<N:0>. The buffer gate L2(3) that is disposed at the “N−1”^{th} bit position BP(N−1) may receive the “N−1”^{th} bit TD1<N−2> of the first transfer data TD1<N:0>. The OR gate L2(4) that is disposed at the “N−2”^{th} bit position BP(N−2) may receive the “N−2”^{th} bit TD1<N−3> and the “N−4”^{th} bit TD1<N−5> (not illustrated) of the first transfer data TD1<N:0>. The buffer gate L2(5) that is disposed at the third bit position BP(3) may receive the third bit TD1<2> of the first transfer data TD1<N:0>.

The AND gate L2(1) that is disposed at the “N+1”^{th} bit position BP(N+1) may perform an AND operation on the “N+1”^{th} bit TD1<N> and the “N−1”^{th} bit TD1<N−2> of the first transfer data TD1<N:0> to generate and output the “N+1”^{th} bit TD2<N> of the second transfer data TD2<N:0>. The AND gate L2(2) that is disposed at the “N”^{th} bit position BP(N) may perform an AND operation on the “N”^{th} bit TD1<N−1> and the “N−2”^{th} bit TD1<N−2> of the first transfer data TD1<N:0> to generate and output the “N”^{th} bit TD2<N−1> of the second transfer data TD2<N:0>. The buffer gate L2(3) that is disposed at the “N−1”^{th} bit position BP(N−1) may output the “N−1”^{th} bit TD1<N−2> of the first transfer data TD1<N:0> as the “N−1”^{th} bit TD2<N−2> of the second transfer data TD2<N:0>. The OR gate L2(4) that is disposed at the “N−2”^{th} bit position BP(N−2) may perform an OR operation on the “N−2”^{th} bit TD1<N−3> and the “N−4”^{th} bit TD1<N−5> (not illustrated) of the first transfer data TD1<N:0> to generate and output the “N−1”^{th} bit TD2<N−2> of the second transfer data TD2<N:0>. The buffer gate L2(5) that is disposed at the third bit position BP(3) may output the third bit TD2<2> of the first transfer data TD1<N:0> as the third bit TD2<2> of the second transfer data TD2<N:0>. At the second bit position BP(2) and the first bit position BP(1), the second bit TD1<1> and the first bit TD1<0> of the first transfer data TD1<N:0> may become the second bit TD2<1> and the first bit TD2<0> of the second transfer data TD2<n:0>, respectively.

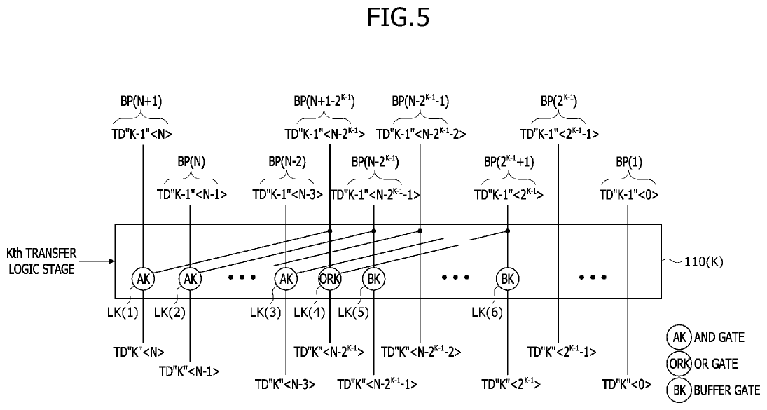

FIG. 5 is a diagram illustrating an example of the “K”^{th} transfer logic stage 110(K) of the fixed binary adder 100 of FIG. 2. In this example, “K” is a natural number of 2 or more and “M−1” or less, and thus, the description of this example may be applied to the second to “M−1”^{th} transfer logic stages. Referring to FIG. 5, The “K”^{th} transfer logic stage 110(K) may also have “N+1” bit positions BP(N+1)-BP(1) like the first and second transfer logic stages 110(1) and 110(2). Each of the “N+1” bit positions BP(N+1)-BP(1) may correspond to each bit of the “N+1”-bit “K−1”^{th} transfer data TD“K−1”<N:0> transmitted from the “K−1”^{th} transfer logic stage. In addition, each of the “N+1” bit positions BP(N+1)-BP(1) may correspond to each bit of the “N+1”-bit “K”^{th} transfer data TD“K”<N:0> that is output from the “K”^{th} transfer logic stage. At the “N+1”^{th} to “2^{K-1}+1”^{th} bit positions BP(N+1)-BP(2^{K-1}+1), among the N+1 bit positions BP(N+1)-BP(1), “N−2^{K-1}” logic gates may be disposed. As shown in the drawings, AND gates (AK) LK(1)-LK(3) may be disposed at the “N+1”^{th} bit position BP(N+1), the “N”^{th} bit position BP(N−2), and the “N−2”^{th} bit position BP(N−2). An OR gate (ORK) LK(4) may be disposed at the “N+1−2^{K-1}”^{th} bit position BP(N+1−2^{K-1}). A buffer gate (BK) LK(5) may be disposed at the “N−2^{K-1}”^{th} bit position BP(N−2^{K-1}). A buffer gate (BK) LK(6) may be fixedly disposed at the “2^{K-1}+1”^{th} bit position BP (2^{K-1}+1) regardless of the value of the first operand. In addition, the logic gates are not disposed at the “2^{K-1}”^{th} to first bit positions BP(2^{K-1})-BP(1). Similar to the case of the first and second transfer logic stages 110(1) and 110(2), the types of logic gates that are disposed at the “N+1”^{th} to “2^{K-1}+1”^{th} bit positions BP(N+1)-BP(2^{K-1}+1) may be determined by values of the first operand, respectively.

The AND gates LK(1)-LK(3), the OR gate LK(4), and the buffer gates LK(5) and LK(6) may each receive a bit, among the bits of the “K−1”^{th} transfer data TD“K−1”<N:0>, corresponding to a bit position at which the logic gate is disposed from the “K−1”^{th} transfer logic stage. In addition, the AND gates LK(1)-LK(3) and the OR gate LK(4) may each receive the bit, among the bits of “K−1”^{th} transfer data TD“K−1”<N:0>, corresponding to the bit position that is lower by “2^{K-1}” bits from the bit position at which the logic gate is disposed from the “K−1”^{th} transfer logic stage, respectively. Specifically, the AND gate LK(1) that is disposed at the “N+1”^{th} bit position BP(N+1) may receive the “N+1”^{th} bit TD“K−1”<N> and the “N+1−2^{K-1}”^{th} bit TD“K−1”<N−2^{K-1}> of the “K−1”^{th} transfer data TD“K−1”<N:0>. The AND gate LK(1) that is disposed at the “N”^{th} bit position BP(N) may receive the “N”^{th} bit TD“K−1”<N−1> and the “N−2^{K-1}”^{th} bit TD“K−1”<N−2^{K-1}−1) of the “K−1”^{th} transfer data TD“K−1”<N:0>. The AND gate LK(3) that is disposed at the “N−2”^{th} bit position BP(N−2) may receive the “N−2”^{th} bit TD“K−1”<N−1> and the “N−2^{K-1}−2”^{th} bit TD“K−1”<N−2^{K-1}−3> (not illustrated) of the “K−1”^{th} transfer data TD“K−1”<N:0>. The OR gate LK(4) that is disposed at the “N−2^{K-1}−2”^{th} bit position BP(N+1−2^{K-1}) may receive the “N+1−2^{K-1}”^{th} bit TD“K−1”<N−2^{K-1}> and the “N+1−2^{K}”^{th} bit TD“K−1”<N+1−2^{K}> (not illustrated) of the “K−1”^{th} transfer data TD“K−1”<N:0>. The buffer gate LK(5) that is disposed at the “N−2^{K-1}”^{th} bit position BP(N−2^{K-1}) may receive the “N−2^{K-1}”^{th} bit TD“K−1”<2^{K-1}−1> of the “K−1”^{th} transfer data TD“K−1”<N:0>. The buffer gate LK(6) that is disposed at the “2^{K-1}+1”^{th} bit position BP(2^{K-1}+1) may receive the “2^{K-1}+1”^{th} bit TD“K−1”<2^{K-1}> of the “K−1”^{th} transfer data TD“K−1”<N:0>.

The AND gate LK(1) that is disposed at the “N+1”^{th} bit position BP(N+1) may perform an AND operation on the “N+1”^{th} bit TD“K−1”<N> and the “N+1−2^{K-1}”^{th} bit TD“K−1”<N−2^{K-1}> of the “K−1”^{th} transfer data TD“K−1”<N:0> to generate and output “N+1”^{th} bit TD“K”<N> of the “K”^{th} transfer data TD“K”<N:0>. The AND gate LK(2) that is disposed at the “N”^{th} bit position BP(N) may perform an AND operation on the “N”^{th} bit TD“K−1”<N−1> and the “N−2^{K-1}”^{th} bit TD“K−1”<N−2^{K-1}−1> of the “K−1”^{th} transfer data TD“K−1”<N:0> to generate and output “N”^{th} bit TD“K”<N−1> of the “K”^{th} transfer data TD“K”<N:0>. The AND gate LK(3) that is disposed at the “N−1”^{th} bit position BP(N−1) may perform an AND operation on the “N−2”^{th} bit TD“K−1”<N−1> and the “N−2^{K-1}−2”^{th} bit TD“K−1”<N−2^{K-1}−3> (not illustrated) of the “K−1”^{th} transfer data TD“K−1”<N:0> to generate and output “N−2”^{th} bit TD“K”<N−3> of the “K”^{th} transfer data TD“K”<N:0>. The OR gate LK(4) that is disposed at the “N−2”^{th} bit position BP(N−2) may perform an OR operation on the “N+1−2^{K-1}”^{th} bit TD“K−1”<N−2^{K-1}> and the “N+1−2^{K}”^{th} bit TD“K−1”<N+1−2^{K}> (not illustrated) of the “K−1”^{th} transfer data TD“K−1”<N:0> to generate and output “N+1−2^{K-1}”^{th} bit TD“K”<N−2^{K-1}> of the “K”^{th} transfer data TD“K”<N:0>. The buffer gate LK(5) that is disposed at the “N−2^{K-1}”^{th} bit position BP(N−2^{K-1}) may output the “N−2K−1”^{th} bit TD“K−1”<N−2^{K-1}−1> of the “K−1”^{th} transfer data TD“K−1”<N:0> as “N−2^{K-1}”^{th} bit TD“K”<N−2^{K-1}−1> of the “K”^{th} transfer data TD“K”<N:0>. The buffer gate LK(6) that is disposed at the “2^{K-1}+1”^{th} bit position BP(2^{K-1}+1) may output the “2^{K-1}+1”^{th} bit TD“K−1”<2^{K-1}> of the “K−1”^{th} transfer data TD“K−1”<N:0> as “2^{K-1}+1”^{th} bit TD“K”<2^{K-1}−1> of the “K”^{th} transfer data TD“K”<N:0>. At the “2^{K-1}”^{th} to first bit positions BP(2^{K-1})-BP(1), the “2^{K-1}”^{th} to first bits TD“K−1”<2^{K-1}−1:0> of the “K−1”^{th} transfer data TD“K−1”<N:0> may become the “2K−1”^{th} to first bits TD“K”<2^{K-1}−1:0> of the “K”^{th} transfer data TD“K”<N:0> as they are, respectively.

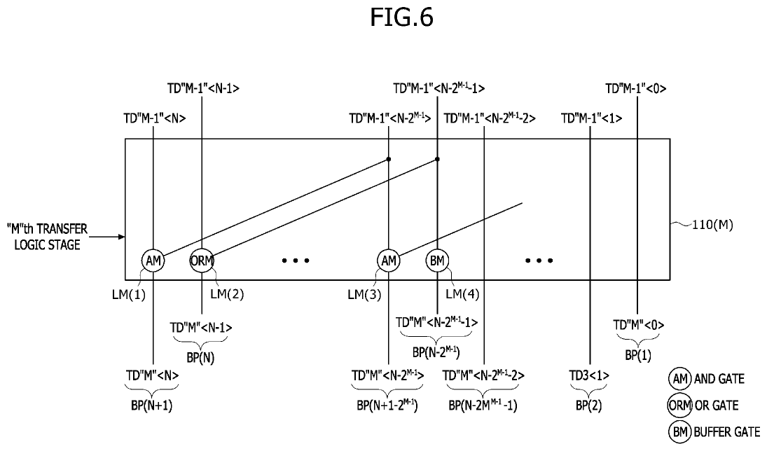

FIG. 6 is a diagram illustrating an example of the “M”^{th} transfer logic stage 110(M) of the fixed binary adder 100 of FIG. 2. Hereinafter, a description overlapping the contents, described with reference to FIG. 2, may be omitted. Referring to FIG. 6, the “M”^{th} transfer logic stage 110(M) may also have “N+1” bit positions BP(N+1)-BP(1) like the first to third transfer logic stages 110(1), 110(2), and 110(3). Each of the “N+1” bit positions BP(N+1)-BP(1) may correspond to each bit of the “N+1”-bit “M−1”^{th} transfer data TD“M−1”<N:0> that is transmitted from the “M−1”^{th} transfer logic stage. At the “N+1”^{th} to “2^{M-1}+1”^{th} bit positions BP(N+1)-BP(2^{M-1}+1), among the “N+1” bit positions BP(N+1)-BP(1), “N−2M−1” logic gates may be disposed. In FIG. 6, only four logic gates L“M”(1)-L“M”(4), among the “N−2M−1” logic gates, are illustrated, and the remaining “(N−2^{M-1})−4” logic gates are omitted. As shown in the drawings, AND gates (Ams) LM(1) and LM(3) are disposed at the “N+1”^{th} bit position BP(N+1) and the “N+1−2^{M-1}”^{th} bit position BP(N+1−2^{M-1}). An OR gate (ORM) LM(2) may be disposed at the “N”^{th} bit position BP(N). A buffer gate (BM) LM(4) may be disposed at a “N−2^{M-1}”^{th} bit position BP(N−2^{M-1}). Although not shown in the drawings, a buffer gate may be fixedly disposed at the “2^{M-1}+1”^{th} bit position BP(2^{M-1}+1). Similar to the cases of the first to third transfer logic stages 110(1), 110(2), and 110(3), types of the logic gates that are disposed at the “N+1”^{th} to “2^{M-1}+2”^{th} bit position BP(N+1)-BP(2^{M-1}+2) may be determined by values of the first operand. In addition, a logic gate might not be disposed at the “2^{M-1}”^{th} bit position BP(2^{M-1}) to the first bit position BP(1).

The AND gates LM(1) and LM(2), the OR gate LM(2), and the buffer gate LM(4) may each receive a bit, among the bits of the “M−1”^{th} transfer data TD“M−1”<N:0>, corresponding to a bit position at which the logic gate is disposed from the “M−1”^{th} transfer logic stage. In addition, the AND gates LM(1) and LM(3), and the OR gate LM(2) may each receive a bit, among the bits of the “M−1”^{th} transfer data TD“M−1”<N:0>, the bit being lower by the “2^{M-1}” bit from the bit position at which the logic gate is disposed from the “M−1”^{th} transfer logic stage. Specifically, the AND gate LM(1) that is disposed at the “N+1”^{th} bit position BP(N+1) may receive the “N+1”^{th} bit TD“M−1”<N> and the “N+1−2^{M-1}”^{th} bit TD“M−1”<N−2^{M-1}> of the “M−1”^{th} transfer data TD“M−1”<N:0>. The OR gate LM(2) that is disposed at the “N”^{th} bit position BP(N) may receive the “N”^{th} bit TD“M−1”<N−1> and the “N−2^{M-1}”^{th} bit TD“M−1”<N−2^{M-1}−1> of the “M−1”^{th} transfer data TD“M−1”<N:0>. The AND gate LM(3) that is disposed at the “N+1−2^{M-1}”^{th} bit position BP(N+1−2^{M-1}) may receive the “N+1−2^{M-1}”^{th} bit TD“M−1”<N−2^{M-1}> and the “N+1−2^{M-1}”^{th} bit TD“M−1”<N+1−2^{M}> (not illustrated) of the “M−1”^{th} transfer data TD“M−1”<N:0>. The buffer gate LM(4) that is disposed at the “N−2^{M-1}”^{th} bit position BP(N−2^{M-1}) may receive the “N−2^{M-1}”^{th} bit TD“M−1”<N−2^{M-1}−1) of the “M−1”^{th} transfer data TD“M−1”<N:0>.

The AND gate LM(1) that is disposed at the “N+1”^{th} bit position BP(N+1) may perform an AND operation on the “N+1”^{th} bit TD“M−1”<N> and the “N+1−2^{M-1}”^{th} bit TD“M−1”<N−2^{M-1}> of the “M−1”^{th} transfer data TD“M−1”<N:0> to generate and output “N+1”^{th} bit TD“M”<N> of the “M”^{th} transfer data TD“M”<N:0>. The OR gate LM(2) that is disposed at the “N”^{th} bit position BP(N) may perform an OR operation on the “N”^{th} bit TD“M−1”<N−1> and the “N−2^{M-1}”^{th} bit TD“M−1”<N−2^{M-1}−1> of the “M−1”^{th} transfer data TD“K−1”<N:0> to generate and output “N”^{th} bit TD“M”<N−1> of the “M”^{th} transfer data TD“M”<N:0>. The AND gate LK(3) that is disposed at the “N+1−2^{M-1}”^{th} bit position BP(N+1−2^{M-1}) may perform an AND operation on the “N+1−2^{M-1}”^{th} bit TD“M−1”<N−2^{M-1}> and the “N+1−2^{M}”^{th} bit TD“M−1”<N+1−2^{M}> (not illustrated) of the “M−1”^{th} transfer data TD“M−1”<N:0> to generate and output “N+1−2^{M-1}”^{th} bit TD“M”<N−2^{M-1}> of the “M”^{th} transfer data TD“M”<N:0>. The buffer gate LM(4) that is disposed at the “N−2^{M-1}”^{th} bit position BP(N−2^{M-1}) may output the “N−2^{M-1}”^{th} bit TD“M−1”<N−2^{M-1}−1> of the “N−1”^{th} transfer data TD“M−1”<N:0> as “N−2^{M-1}”^{th} bit TD“M”<N−2^{M-1}−1> of the “M”^{th} transfer data TD“M”<N:0>. At the “2^{M-1}”^{th} to first bit positions BP(2^{M-1})-BP(1), the “2^{M-1}”^{th} to first bits TD“M−1”<2^{M-1}−1:0> of the “M−1”^{th} transfer data TD“M−1”<N:0> may become the “2^{M-1}”^{th} to first bits TD“M”<2^{M-1}−1:0> of the “M”^{th} transfer data TD“M”<N:0>, respectively, as they are.

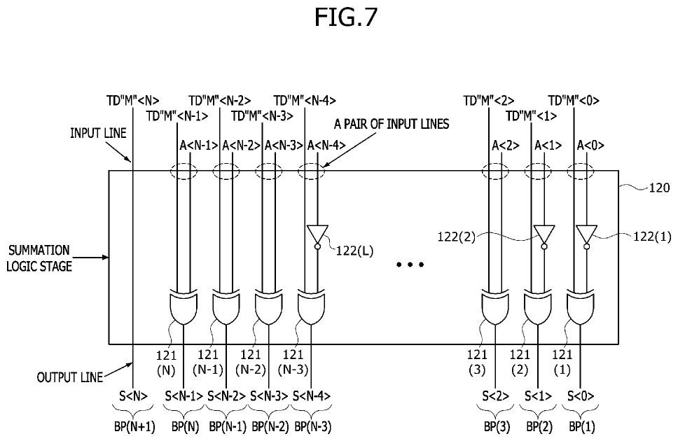

FIG. 7 is a diagram illustrating an example of the summation logic stage 120 of the fixed binary adder 100 of FIG. 2. Hereinafter, a description overlapping the contents, described with reference to FIG. 2, may be omitted. Referring to FIG. 7, the summation logic stage 120 may also include “N+1” bit positions BP(N+1)-BP(1) like the first to “M”^{th} transfer logic stages 110(1)-110(M). Each of the “N+1” bit positions BP(N+1)-BP(1) may correspond to a bit of the “N+1” M^{th} transfer data TD“M”<N:0> that is transmitted from the “M”^{th} transfer logic stage 110(M). That is, each of the bits of the M^{th} transfer data TD“M”<N:0> may be transmitted to each of the “N+1” bit positions BP(N+1)-BP(1). Each of the “N+1” bit positions BP(N+1)-BP(1) of the summation logic stage 120 may correspond to each of the bits of the output data S<N:0>. That is, each bit of the output data S<N:0> may be output from the summation logic stage 120 via a path of each of the “N+1” bit positions BP(N+1)-BP(1) of the summation logic stage 120.

At the input stage of the summation logic stage 120, an input line may be disposed at the “N+1”^{th} bit position BP(N+1). An input line pair including two input lines may be disposed at each of the “N”^{th} to first bit positions BP(N)-BP(1). At the output stage of the summation logic stage 120, an output line may be disposed at each of the “N+1”^{th} to first bit positions BP(N+1)-BP(1). The input line and the output line at the “N+1”^{th} bit position BP(N+1) may be coupled in a connection structure in which an input value and an output value are maintained the same. In an example, as shown in FIG. 7, the input line and the output line at the “N+1”^{th} bit position BP(N+1) may be directly connected to each other. Although not shown in FIG. 7, in another example, the input line and the output line at the “N+1”^{th} bit position BP(N+1) may be connected through at least one buffer gate.

The “M”^{th} transfer data TD“M”<N:0> that is transmitted from the “M”^{th} transfer logic stage 110(M) may be input through the input line at the “N+₁”^{th} bit position BP(N+1) and the input line of each of the input line pairs at the “N”^{th} to first bit positions BP(N)-BP(1). Specifically, a most significant bit of the “M”^{th} transfer data TD“M”<N:0>, that is, the “N+1”^{th} bit TD“M”<N> may be input through the input line of the “N+1”^{th} bit position BP(N+1). The “N”^{th} to first bits TD“M”<N−1:0> of the “M”^{th} transfer data TD“M”<N:0> may be input through one input line of each of the input line pairs at the “N”^{th} to first bit positions BP(N)-BP(1). That is, the “M”^{th} bit TD“M”<N−1> of the “M”^{th} transfer data TD“M”<N:0> may be input through an input line of the input line pair at the “N”^{th} bit position BP(N). The “M−1”^{th} bit TD“M”<N−2> of the “M”^{th} transfer data TD“M”<N:0> may be input through an input line of the input line pair at the “N−1”^{th} bit position BP(N−1). Similarly, the first bit TD“M”<0> of the “M”^{th} transfer data TD“M”<N:0> may be input through an input line of the input line pair at the first bit position BP(1).

A second operand A<N−1:0> may be input through the other input line of each of the input line pairs at the “N”^{th} to first bit positions BP(N)-BP(1). Specifically, a most significant bit of the second operand A<N−1:0>, that is, the “N”^{th} bit A<N−1> may be input through the other input line of the input line pair at the “N”^{th} bit position BP(N). The “N−1”^{th} bit A<N−2> of the second operand A<N−1:0> may be input through the other input line of the input line pair at the “N−1”^{th} bit position BP(N−1). Similarly, the first bit A<0> of the second operand A<N−1:0> may be input through the other input line of the input line pair at the first bit position BP(1).

The summation logic stage 120 may include “N” XOR gates 121(N)-121(N−3), . . . , 121(3)-121(1) and “L” NOT gates 122(L)-122(1) (“L” is a natural number greater than or equal to 1 and less than or equal to “N”). The “N” XOR gates 121(N)-121(N−3), . . . , 121(3)-121(1) may be disposed at the “N”^{th} to first bit positions BP(N)-BP(1), respectively. FIG. 7 illustrates only the 7 XOR gates 120(N)-120(N−3), and 120(3)-120(1), among the “N” XOR gates 121(N)-121(N−3), . . . , 121(3)-121(1), and the remaining “N−7” XOR gates are omitted. No logic gate is disposed at the “N+1”^{th} bit position BP(N+1) of the summation logic stage 120. Accordingly, the “N+1”^{th} bit TD“M”<N> of the “M”^{th} transfer data TD“M”<N:0> that is transmitted from the “M”^{th} transfer logic stage 120(M) to the “N+1”^{th} bit position BP(N+1) of the summation logic stage 120 may be output as the “N+1”^{th} bit S<N> of the output data S<N:0> from the summation logic stage 120.

Each of the XOR gates 121(N)-121(N−3), . . . , 121(3)-121(1) may include two input terminals and one output terminal. One of the two input terminals of each of the XOR gates 121(N)-121(N−3), . . . , 121(3)-121(1) may be coupled to one input line of each of the input line pairs through which the “M”^{th} to first bits TD“M”<N−1:0> of the “M”^{th} transfer data TD“M”<N:0> are transmitted. Accordingly, the XOR gate 121(N) of the “N”^{th} bit position BP(N) may receive the “N”^{th} bit TD“M”<N−1> of the “M”^{th} transfer data TD“M”<N:0> through one input terminal. The XOR gate 121(N−1) of the “N−1”^{th} bit position BP(N−1) may receive the “N−1”^{th} bit TD“M”<N−2> of the “M”^{th} transfer data TD“M”<N:0> through one input terminal. Similarly, the XOR gate 121(1) of the first bit position BP(1) may receive the first bit TD“M”<0> of the “M”^{th} transfer data TD“M”<N:0> through one input terminal.

The other one of the two input terminals of each of the XOR gates 121(N)-121(N−3), . . . , 121(3)-121(1) may be directly coupled to the other input line of each of the input line pairs through which the second operand A<N−1:0> is transmitted or may be coupled through the NOT gate. Hereinafter, the XOR gates of which the other one of the two input terminals is directly coupled to the other input line of the input line pairs through which the second operand A<N−1:0> is transmitted will be classified into a first group, and the XOR gates coupled through the NOT gate will be classified into a second group. In this case, the XOR gates of the first group may receive bits of the second operand A<N−1:0> through the second input terminal. As shown in the drawings, the XOR gates 121(N)-121(N−2) that are disposed at the “N”^{th} to “N−2”^{th} bit positions BP(N)-BP(N−2) and the XOR gate 121(3) that are disposed at the third bit position BP3 may belong to the first group. On the other hand, the XOR gates 121(N−3), 121(2), and 121(1) that are disposed at the “N−3”^{th}, second, and first bit positions BP(3), BP(2), and BP(1) may belong to the second group.

Whether the XOR gates 121(N)-121(N−3), . . . , 121(3)-121(1) belong to the first group or the second group may be determined according to the first operand. For example, when the “N”^{th} to first bit positions BP(N)-BP(1) correspond to each of bits of the first operand, the XOR gate of the first group may be disposed at the bit position that corresponds to a bit having a value of “0” in the binary stream of the first operand. On the other hand, the XOR gate of the second group may be disposed at the bit position that corresponds to a bit having a value of “1” in the binary stream of the first operand. As shown in FIG. 7, the fact that the XOR gates 121(N)-121(N−2), 121(3) of the first group are disposed at the “N”^{th} to “N−2”^{th} and third bit positions BP(N)-BP(N−2), and BP(3) may indicate that the “N”^{th} to “N−2”^{th} and third bits of the first operand are “0”. In addition, the fact that the XOR gates 121(N−3), 121(2), and 121(3) of the second group are disposed at the “N−3”^{th}, second, and first bit positions BP(N−3), BP(2), and BP(1) may indicate that the “N−3”^{th}, second, and third bits of the first operand are “1”. In other words, the fact that the summation logic stage 120 includes “L” NOT gates 122(L)-122(1) may indicate that there are “L” bits with a value of “1” in the first operand of the fixed binary adder 100.

As shown in FIG. 7, the XOR gate 121(N) at the “N”^{th} bit position BP(N) may perform an XOR operation on the “N”^{th} bit TD“M”<N−1> of the “M”^{th} transfer data TD“M”<N:0> and the “N”^{th} bit A<N−1> of the second operand to generate and output “N”^{th} bit S<N−1> of the output data S<N:0>. The XOR gate 121(N−1) at the “N−1”^{th} bit position BP(N−1) may perform an XOR operation on the “N−1”^{th} bit TD“M”<N−2> of the “M”^{th} transfer data TD“M”<N:0> and the “N−1”^{th} bit A<N−2> of the second operand to generate and output “N−1”^{th} bit S<N−2> of the output data S<N:0>. The XOR gate 121(N−1) at the “N−2”^{th} bit position BP(N−2) may perform an XOR operation on the the “N−2”^{th} bit TD“M”<N−3> of the “M”^{th} transfer data TD“M”<N:0> and the “N−2”^{th} bit A<N−3> of the second operand to generate and output “N−2”^{th} bit S<N−3> of the output data S<N:0>. The XOR gate 121(N−3) at the “N−3”^{th} bit position BP(N−3) may perform an XOR operation on the “N−3”^{th} bit TD“M”<N−4> of the “M”^{th} transfer data TD“M”<N:0> and the “N−3”^{th} bit A<N−4> of the second operand to generate and output “N−3”^{th} bit S<N−4> of the output data S<N:0>. The XOR gate 121(3) at the third bit position BP(3) may perform an XOR operation on the third bit TD“M”<2> of the “M”^{th} transfer data TD“M”<N:0> and the third bit A<2> of the second operand to generate and output third bit S<2> of the output data S<N:0>. The XOR gate 121(2) at the second bit position BP(2) may perform an XOR operation on the second bit TD“M”<1> of the “M”^{th} transfer data TD“M”<N:0> and the second bit A<1> of the second operand to generate and output second bit S<1> of the output data S<N:0>. The XOR gate 121(1) at the first bit position BP(1) may perform an XOR operation on the first bit TD“M”<0> of the “M”^{th} transfer data TD“M”<N:0> and the first bit A<0> of the second operand to generate and output first bit S<0> of the output data S<N:0>.

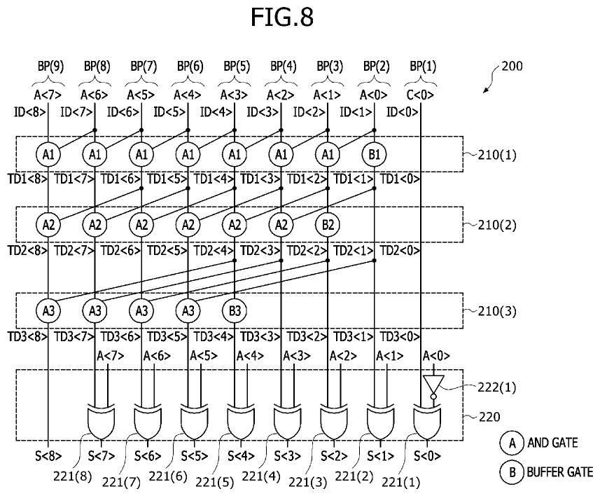

FIG. 8 is a diagram illustrating a “+1” fixed binary adder 200 according to an embodiment of the present disclosure. The “+1” fixed binary adder 200, according to the present embodiment of the present disclosure, may perform an addition operation on a first operand having a 8-bit fixed value and a 8-bit second operand A<7:0>. The first operand may be fixed to “0000 0001”. Since the “+1” fixed binary adder 200 performs 8-bit addition operation, this embodiment may correspond to the case in which “N” is 8 (“M” is 3) and “L” is 1 in FIGS. 2 to 7. Referring to FIG. 8, the “+1” fixed binary adder 200 may include ninth to first bit positions BP(9)-BP(1) that respectively correspond to the bits of input data ID<8:0>. The ninth to first bit positions BP(9)-BP(1) may also correspond to bits of transfer data TD<8:0> that is output from transfer logic stages, and the ninth to first bit positions BP(9)-BP(1) may also correspond to bits of output data S<8:0>. The input data ID<8:0> may be constituted with 8-bit second operand A<7:0> and 1-bit carry-in data C<0>. The carry-in data C<0> may have a fixed value of “0”. The “+1” fixed binary adder 200 may perform a “+1” (i.e., +0000 0001) operation on the second operand A<7:0> to generate and output 9-bit output data S<8:0>. The “+1” fixed binary adder 200 may include three transfer logic stages 210(1)-210(3) and a summation logic stage 220.

The first transfer logic stage 210(1) may include seven AND gates A1s and one buffer gate B1. The AND gates A1s may be disposed at the ninth to third bit positions BP(9)-BP(3) of the first transfer logic stage 210(1). The buffer gate B1 may be disposed at the second bit position BP(2) of the first transfer logic stage 210(1). A logic gate might not be disposed at the first bit position BP(1) of the first transfer logic stage 210(1). The AND gate A1 that is disposed at the ninth bit position BP(9) of the first transfer logic stage 210(1) may perform an AND operation on the ninth bit ID<8> and the eighth bit ID<7> of the input data ID<8:0> to generate and output a ninth bit TD1<8> of the first transfer data TD1<8:0>. In the same manner, the AND gates A1s that are disposed at the eighth to third bit positions BP(8)-BP(3) of the first transfer logic stage 210(1) may also generate and output eighth to third bits TD1<7:2> of the first transfer data TD1<8:0>. The buffer gate B1 that is disposed at the second bit position BP(2) of the first transfer logic stage 210(1) may output the second bit ID<1> of the input data ID<8:0> as a second bit TD1<1> of the first transfer data TD1<8:0> as it is. The first bit TD1<0> of the first transfer data TD1<8:0> may have the same value as the first bit ID<0> of the input data ID<8:0>, that is, the carry-in data C<0>.

The second transfer logic stage 210(2) may include six AND gates A2s and one buffer gate B2. The AND gates A2s may be disposed at the ninth to fourth bit positions BP(9)-BP(4) of the second transfer logic stage 210(2). The buffer gate B2 may be disposed at the third bit position BP(3) of the second transfer logic stage 210(2). A logic gate might not be disposed at the second bit position BP(2) and the first bit position BP(1) of the second transfer logic stage 210(2). The AND gate A2 that is disposed at the ninth bit position BP(9) of the second transfer logic stage 210(2) may perform an AND operation on the ninth bit TD1<8> and the seventh bit TD1<6> of the first transfer data TD1<8:0> to generate and output a ninth bit TD2<8> of the second transfer data TD2<8:0>. In the same manner, the AND gates A2s that are disposed at the eighth to fourth bit positions BP(8)-BP(4) of the second transfer logic stage 210(2) may also generate and output eighth to fourth bits TD2<7:3> of the second transfer data TD2<8:0>. The buffer gate B2 that is disposed at the third bit position BP(3) of the second transfer logic stage 210(2) may output the third bit TD1<2> of the first transfer data TD1<8:0> as a third bit TD2<2> of the second transfer data TD2<8:0> as it is. The second bit TD2<1> and the first bit TD2<0> of the second transfer data TD2<8:0> may have the same value as the second bit TD1<1> and the first bit TD1<0> of the first transfer data TD1<8:0>, respectively.

The third transfer logic stage 210(3) may include four AND gates A3s and one buffer gate B3. The AND gates A2s may be disposed at the ninth to sixth bit positions BP(9)-BP(6) of the third transfer logic stage 210(3). The buffer gate B3 may be disposed at the fifth bit position BP(5) of the third transfer logic stage 210(3). A logic gate might not be disposed at the fourth to first bit positions BP(4)-BP(1) of the third transfer logic stage 210(3). The AND gate A3 that is disposed at the ninth bit position BP(9) of the third transfer logic stage 210(3) may perform an AND operation on the ninth bit TD2<8> and the fifth bit TD2<4> of the second transfer data TD2<8:0> to generate and output a ninth bit TD3<8> of the third transfer data TD3<8:0>. In the same manner, the AND gates A3s that are disposed at the eighth to sixth bit positions BP(8)-BP(6) of the third transfer logic stage 210(3) may also generate and output eighth to sixth bits TD3<7:5> of the third transfer data TD3<8:0>. The buffer gate B3 that is disposed at the fifth bit position BP(5) of the third transfer logic stage 210(3) may output the fifth bit TD2<4> of the second transfer data TD2<8:0> as a fifth bit TD3<4> of the third transfer data TD3<8:0> as it is. A fourth bit TD3<3>, a third bit TD3<2>, a second bit TD3<1>, and a first bit TD3<0> of the third transfer data TD3<8:0> may have the same values as the fourth bit TD2<3>, the third bit TD2<2>, the second bit TD2<1>, and the first bit TD2<0> of the second transfer data TD2<8:0>, respectively.

The summation logic stage 220 may receive the third transfer data TD3<8:0> and the second operand A<7:0> that is output from the third transfer logic stage 210(3). Because the first operand is “0000 0001”, the XOR gates 221(8)-221(2), among the eight XOR gates 221(8)-221(1) of the summation logic stage 220, disposed at the eighth to second bit positions BP(8)-BP(2), may belong to a first group. On the other hand, the XOR gate 221(1) that is disposed at the first bit position BP(1) may belong to a second group. The XOR gates 221(8)-221(2) of the first group may receive the eighth to second bits TD3<7:1> of the third transfer data TD3<8:0> through one input terminal. The XOR gates 221(8)-221(2) of the first group may receive the eighth to second bits A<7:1> of the second operand A<7:0> through the other input terminal. The XOR gate 221(1) of the second group may receive the first bit TD3<0> of the third transfer data TD3<8:0> through one input terminal. The first bit A<0> of the second operand A<7:0> may be input to a NOT gate 221(1) that is disposed at the first bit position BP(1). The NOT gate 222(1) may transmit an inverted bit of the first bit A<0> of the second operand A<7:0> to the other input terminal of the XOR gate 221(1) of the second group.

The ninth bit TD3<8> of the third transfer data TD3<8:0> that is transmitted to the ninth bit position BP(9) of the summation logic stage 220 may be output from the summation logic stage 220 as a ninth bit S<8> of the output data S<8:0> as it is. The XOR gate 221(8) at the eighth bit position BP(8) may perform an XOR operation on the eighth bit TD3<7> of the third transfer data TD3<8:0> and the eighth bit A<7> of the second operand A<7:0> to generate and output an eighth bit S<7> of the output data S<8:0>. The XOR gate 321(7) at the seventh bit position BP(7) may perform an XOR operation on the seventh bit TD3<6> of the third transfer data TD3<8:0> and the seventh bit A<6> of the second operand A<7:0> to generate and output a seventh bit S<6> of the output data S<8:0>. The XOR gates 221(6)-221(2) at the sixth to second bit positions BP(6)-BP(2) may output sixth to second bits S<5:1> of the output data S<8:0> in the same manner. The XOR gate 221(1) of the first bit position BP(1) may perform an XOR operation on the first bit TD3<0> of the third transfer data TD3<8:0> and the inverted bit of the first bit A<0> of the second operand A<7:0> to generate and output a first bit S<0> of the output data S<8:0>.

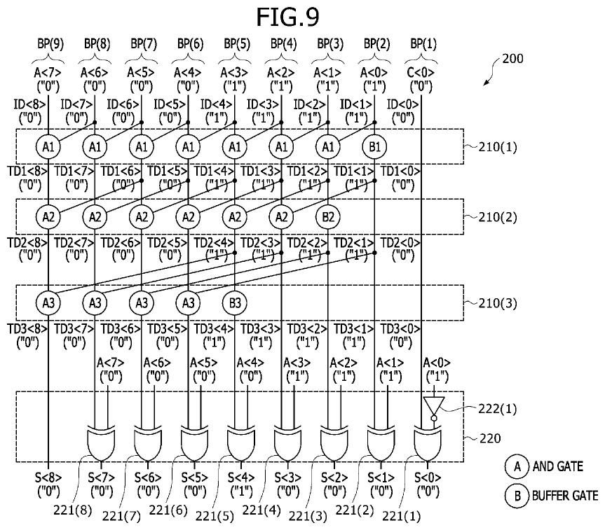

FIG. 9 is a diagram illustrating an addition operation of the “+1” fixed binary adder 200 of FIG. 8. In FIG. 9, the same reference numerals as in FIG. 8 denote the same elements. In the present embodiment, a case in which the second operand A<7:0> is +15, that is, “0000 1111”, will be described as an example. It is assumed that the carry-in data C<0> is “0”. Referring to FIG. 9, input data ID<8:0> which is a binary stream of “0 0001 1110” may be input to the first transfer logic stage 210(1). In the first transfer logic stage 210(1), the AND gate A1 of the ninth bit position BP(9) may perform an AND operation on the ninth bit ID<8>“0” of the input data ID<8:0> and the eighth bit ID<7>“0” of the input data ID<8:0> and may output “0” that is generated as a result of the AND operation as the ninth bit TD1<8> of the first transfer data TD1<8:0>. In the same manner, the AND gates A1s of the eighth to sixth bit positions BP(8)-BP(6) may output “0” as the eighth to sixth bits TD1<7:5> of the first transfer data TD1<8:0>, respectively. The AND gate A1 at the fifth bit position BP(5) may perform an AND operation on the fifth bit ID<4>“1” of the input data ID<8:0> and the fourth bit ID<3>“1” of the input data ID<8:0> and may output “1” that is generated as a result of the AND operation as the fifth bit TD1<4> of the first transfer data TD1<8:0>. In the same manner, the AND gates A1s of the fourth and third bit positions BP(3) and BP(4) may output “1” as the fourth and third bits TD1<3:2>, respectively. The buffer gate B1 of the second bit position BP(2) may output the second bit ID<1>“1” of the input data ID<8:0> as it is, as the second bit TD1<1> of the first transfer data TD1<8:0>. The first bit TD1<0> of the first transfer data TD1<8:0> may be the same as the first bit ID<0>“0” of the input data ID<8:0>. As a result, the first transfer logic stage 210(1) may output a binary stream of “0 0001 1110” as the first transfer data TD1<8:0>.

The first transfer data TD1<8:0> of “0 0001 1110” may be input to the second transfer logic stage 210(2). In the second transfer logic stage 210(2), the AND gate A2 of the ninth bit position BP(9) may perform an AND operation on the ninth bit TD1<8>“0” of the first transfer data TD1<8:0> and the seventh bit TD1<6>“0” of the first transfer data TD1<8:0> and may output “0” that is generated as a result of the AND operation as the ninth bit TD2<8> of the second transfer data TD2<8:0>. In the same manner, the AND gate A1 at the eighth bit position BP(8) may output “0” as the eighth bit TD2<7> of the second transfer data TD2<8:0>. The AND gate A1 at the seventh bit position BP(7) may perform an AND operation on the seventh bit TD1<6>“0” and the fifth bit TD1<4>“1” of the first transfer data TD1<8:0> and may output “0” that is generated as a result of the AND operation as the seventh bit TD2<6> of the second transfer data TD2<8:0>. In the same manner, the AND gate A2 at the sixth bit position BP(6) may output “0” as the sixth bit TD2<5> of the second transfer data TD2<8:0>. The AND gate A2 at the fifth bit position BP(5) may perform an AND operation on the fifth bit TD1<4>“1” and the third bit TD1<2>“1” of the first transfer data TD1<8:0> and may output “1” that is generated as a result of the AND operation as the fifth bit TD2<4> of the second transfer data TD2<8:0>. In the same manner, the AND gate A2 at the fourth bit position BP(4) may output “1” as the fourth bit TD2<3> of the second transfer data TD2<8:0>. The buffer gate B2 at the third bit position BP(3) may output the third bit TD1<2>“1” of the first transfer data TD1<8:0> as it is as the third bit TD2<2> of the second transfer data TD2<8:0>. The second and first bits TD2<1:0> of the second transfer data TD2<8:0> may be the same as the second and first bits TD1<1:0>“10” of the first transfer data TD1<8:0>, respectively. As a result, the second transfer logic stage 210(2) may output a binary stream of “0 0001 1110” as the second transfer data TD2<8:0>.

The second transfer data TD2<8:0> of “0 0001 1110” may be input to the third transfer logic stage 210(3). In the third transfer logic stage 210(3), the AND gate A3 of the ninth bit position BP(9) may perform an AND operation on the ninth bit TD2<8>“0” of the second transfer data TD2<8:0> and the fifth bit TD2<4>“1” of the second transfer data TD2<8:0> and may output “0” that is generated as a result of the AND operation as the ninth bit TD3<8> of third transfer data TD3<8:0>. In the same manner, the AND gates A3s at the eighth to sixth bit positions BP(8)-BP(6) may output “0” as the eighth to sixth bits TD3<7:5> of the third transfer data TD3<8:0>, respectively. The buffer gate B3 at the fifth bit position BP(5) may output the fifth bit TD2<4>“1” of the second transfer data TD2<8:0> as it is as the fifth bit TD3<4> of the third transfer data TD3<8:0>. The fourth to first bits TD3<3:0> of the third transfer data TD3<8:0> may be the same as the fourth to first bits TD2<3:0>“1110” of the second transfer data TD2<8:0>, respectively. As a result, the third transfer logic stage 210(3) may output a binary stream of “0 0001 1110” as the third transfer data TD3<8:0>.

The third transfer data TD3<8:0> of “0 0001 1110” and the second operand A<7:0> of “0000 1111” may be input to the summation logic stage 220. The ninth bit TD3<8>“0” of the third transfer data TD3<8:0> that is input at the ninth bit position BP(9) of the summation logic stage 220 may be output as the ninth bit S<8> of the output data S<8:0>. The XOR gate 221(8) at the eighth bit position BP(8) may perform an XOR operation on the eighth bit TD3<7>“0” of the third transfer data TD3<8:0> and the eighth bit A<7>“0” of the second operand A<7:0> to output “0” as the eighth bit S<7> of the output data S<8:0>. In the same manner, the XOR gates 221(7) and 221(6) at the seventh and sixth bit positions BP(7) and BP(6) may output “0” as the seventh and sixth bits S<6:5> of the output data S<8:0>, respectively. The XOR gate 221(5) at the fifth bit position BP(5) may perform an XOR operation on the fifth bit TD3<4>“1” of the third transfer data TD3<8:0> and the fifth bit A<4>“0” of the second operand A<7:0> to output “1” as the fifth bit S<4> of the output data S<8:0>. The XOR gate 221(4) at the fourth bit position BP(4) may perform an XOR operation on the fourth bit TD3<3>“1” of the third transfer data TD3<8:0> and the fourth bit A<3>“1” of the second operand A<7:0> to output “0” as the fourth bit S<3> of the output data S<8:0>. In the same manner, the XOR gates 221(3) and 221(2) at the third and second bit positions BP(3) and BP(2) may output “0” as the third and second bits S<2:1> of the output data S<8:0>, respectively. The XOR gate 221(1) at the first bit position BP(1) may perform an XOR operation on the first bit TD3<0>“0” of the third transfer data TD3<8:0> and the inverted bit of the first bit TD3<0>“1” of the second operand A<7:0>, that is, “0” to output “0” as the first bit S<0> of the output data S<8:0>. As a result, the summation logic stage 220 may output “0 0001 0000” as result data S<8:0> that is obtained by adding “0000 1111” as the second operand A<7:0> to the fixed value “00001” as the first operand.

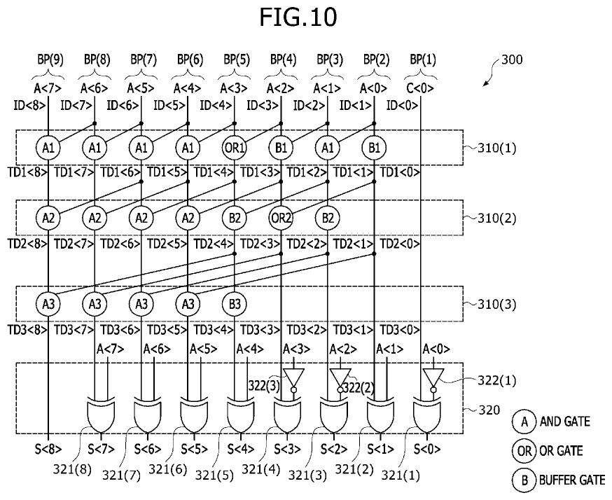

FIG. 10 is a diagram illustrating a “+13” fixed binary adder 300 according to another embodiment of the present disclosure. The “+13” fixed binary adder 300, according to the present embodiment, may perform an addition operation on a first operand having a 8-bit fixed value and a 8-bit second operand A<7:0>. The first operand may be fixed as “00001101”. Since the “+13” fixed binary adder 300 performs an 8-bit addition operation, it may correspond to a case in which “N” is 8 (“M” is 3) and “L” is 3 in FIGS. 2 to 7. Referring to FIG. 10, the “+13” fixed binary adder 300 may have ninth to first bit positions BP(9)-BP(1) that correspond to bits of input data ID<8:0>. The ninth to first bit positions BP(9)-BP(1) may correspond to each bit of the transfer data TD<8:0> that is output from each transfer logic stage and may also correspond to each bit of the output data S<8:0>. The input data ID<8:0> may include 8-bit second operand A<7:0> and 1-bit carry-in data C<0>. The carry-in data C<0> may have a fixed value of “0”. The “+13” fixed binary adder 300 may perform “+13” operation, an operation of adding “0000 1101” to the second operand A<7:0> to generate and output 9-bit output data S<8:0>. The “+13” fixed binary adder 300 may include three transfer logic stages 310(1)-310(3) and a summation logic stage 320.

The first transfer logic stage 310(1) may include five AND gates A1s, one OR gate OR1, and two buffer gates B1s. The AND gates A1s may be disposed at the ninth to sixth, and third bit positions BP(9)-BP(6), and BP(3) of the first transfer logic stage 310(1). The OR gate OR1 may be disposed at the fifth bit position BP(5). The buffer gates B1s may be disposed at the fourth and second bit positions BP(4) and BP(2). A logic gate might not be disposed at the first bit position BP(1) of the first transfer logic stage 310(1). The AND gate A1 that is disposed at the ninth bit position BP(9) of the first transfer logic stage 310(1) may perform an AND operation on the ninth bit ID<8> and the eighth bit ID<7> of the input data ID<8:0> to generate and output a ninth bit TD1<8> of the first transfer data TD1<8:0>. In the same manner, the AND gates A1s that are disposed at the eighth to sixth, and third bit positions BP(8)-BP(6), and BP(3) of the first transfer logic stage 310(1) may generate and output eighth to sixth, and third bits TD1<7:5> and TD1<2> of the first transfer data TD1<8:0>. The OR gate OR1 that is disposed at the fifth bit position BP(5) of the first logic stage 310(1) may perform an OR operation on the fifth bit ID<4> and the fourth bit ID<3> of the input data ID<8:0> to generate and output a fifth bit TD1<4> of the first transfer data TD1<8:0>. The buffer gates B1s that are disposed at the fourth and second bit positions BP(4) and BP(2) of the first transfer logic stage 310(1) may output the fourth bit ID<3> and the second bit ID<1> of the input data ID<8:0> as they are as a fourth bit TD1<3> and a second bit TD1<1> of the first transfer data TD1<8:0>, respectively. The first bit TD1<0> of the first transfer data TD1<8:0> may have the same value as the first bit ID<0> of the input data ID<8:0>.

The second transfer logic stage 310(2) may include four AND gates A2s, one OR gate OR2, and two buffer gates B2s. The AND gates A2s may be disposed at the ninth to sixth bit positions BP(9)-BP(6) of the second transfer logic stage 310(2). The OR gate OR2 may be disposed at the fourth bit position BP(4) of the second transfer logic stage 310(2). The buffer gates B2s may be disposed at the fifth and third bit positions BP(5) and BP(3) of the second transfer logic stage 310(2). The second transfer logic stage 310(2) might not have logic gates at the second bit position BP(2) and the first bit position BP1. The AND gate A2 that is disposed at the ninth bit position BP(9) of the second transfer logic stage 310(2) may perform an AND operation on the ninth bit TD1<8> and the seventh bit TD1<6> of the first transfer data TD1<8:0> to generate and output a ninth bit TD2<8> of the second transfer data TD2<8:0>. In the same manner, the AND gates A1s that are disposed at the eighth to sixth bit positions BP(8)-BP(6) of the second transfer logic stage 310(2) may generate and output eighth to sixth bits TD1<7:5> of the second transfer data TD2<8:0>. The OR gate OR2 that is disposed at the fourth bit position BP(4) of the second logic stage 310(2) may perform an OR operation on the fourth bit TD1<4> and the second bit TD1<3> of the first transfer data TD1<8:0> to generate and output a fourth bit TD2<3> of the second transfer data TD2<8:0>. The buffer gates B2s that are disposed at the fifth and third bit positions BP(5) and BP(3) of the second transfer logic stage 310(2) may output the fifth bit TD1<4> and the third bit TD1<2> of the first transfer data TD1<8:0> as they are as a fifth bit TD2<4> and a third bit TD2<2> of the second transfer data TD2<8:0>, respectively. The second bit TD2<1> and the first bit TD2<0> of the second transfer data TD2<8:0> may have the same value as the second bit TD1<1> and the first bit TD1<0> of the first transfer data TD1<8:0>.

The third transfer logic stage 310(3) may include four AND gates A3s and one buffer gate B3. The AND gates A3s may be disposed at the ninth to sixth bit positions BP(9)-BP(6) of the third transfer logic stage 310(3). The buffer gate B3 may be disposed at the fifth bit position BP(5) of the third transfer logic stage 310(3). The third transfer logic stage 310(3) might not have logic gates at the fourth to first bit positions BP(4)-BP(1). The AND gate A3 that is disposed at the ninth bit position BP(9) of the third transfer logic stage 310(3) may perform an AND operation on the ninth bit TD2<8> and the fifth bit TD2<4> of the second transfer data TD2<8:0> to generate and output a ninth bit TD3<8> of the third transfer data TD3<8:0>. In the same manner, the AND gates A3s that are disposed at the eighth to sixth bit position BP(8)-BP(6) of the third transfer logic stage 310(3) may also generate and output eighth to sixth bits TD2<7:5> of the third transfer data TD3<8:0>. The buffer gate B3 that are disposed at the fifth bit position BP(5) of the third transfer logic stage 310(3) may output the fifth bit TD2<4> of the second transfer data TD2<8:0> as it is as a fifth bit TD2<4> of the third transfer data TD3<8:0>. A fourth bit TD3<3>, a third bit TD3<2>, a second bit TD3<1>, and a first bit TD3<0> of the third transfer data TD3<8:0> may have the same values as the fourth bit TD2<3>, the third bit TD2<2>, the second bit TD2<1>, and the first bit TD2<0> of the second transfer data TD2<8:0>, respectively.

The summation logic stage 320 may receive the third transfer data TD3<8:0> that is output from the third transfer logic stage 310(3) and the second operand A<7:0>. Because the first operand is “0000 1101”, the XOR gates 321(8)-321(5), and 321(2), among the eight XOR gates 321(8)-321(1) of the summation logic stage 320, disposed at the eighth to fifth, and second bit positions BP(8)-BP(5) and BP(2), may belong to a first group. On the other hand, the XOR gates 321(4), 321(3), and 321(1) that are disposed at the fourth, third, and first bit positions BP(4), BP(3), and BP(1) may belong to a second group. The XOR gates 321(8)-321(5), and 321(2) of the first group may receive the eighth to fifth, and second bits TD3<7:4>, and TD3<1> of the third transfer data TD3<8:0> through one input terminal. The XOR gates 321(8)-321(5), and 321(2) of the first group may receive the eighth to fifth, and second bits A<7:4>, and A<1> of the second operand A<7:0> through the other input terminal. The XOR gates 321(4), 321(3), and 321(1) of the second group may receive the fourth, third, and first bits TD3<3>, TD3<2>, and TD3<0> of the third transfer data TD3<8:0>, respectively, through one input terminal. The fourth, third, and first bits A<3>, A<2>, and A<0> of the second operand A<7:0> may be input to NOT gates 322(3)-322(1) that are disposed at the fourth, third, and first bit positions BP(4), BP(3), and BP(1), respectively. The NOT gates 322(3)-322(1) may transmit inverted bits of the fourth, third, and second bits A<3>, A<2>, and A<0> of the second operand A<7:0> through the other input terminals of each of the XOR gates 321(4), 321(3), and 321(1), respectively.

The ninth bit TD3<8> of the third transfer data TD3<8:0> that is transmitted to the ninth bit position BP(9) of the summation logic stage 320 may be output from the summation logic stage 320 as it is as a ninth bit S<8> of the output data S<8:0>. The XOR gate 321(8) of the eighth bit position BP(8) may perform an XOR operation on the eighth bit TD3<7> of the third transfer data TD3<8:0> and the eighth bit A<7> of the second operand A<7:0> to generate and output an eighth bit S<7> of the output data S<8:0>. The XOR gate 321(7) of the seventh bit position BP(7) may perform an XOR operation on the seventh bit TD3<6> of the third transfer data TD3<8:0> and the seventh bit A<6> of the second operand A<7:0> to generate and output a seventh bit S<6> of the output data S<8:0>. The XOR gates 321(6), 321(5), and 321(2) of the sixth, fifth, and second bit positions BP(6), BP(5), and BP(2) may generate and output sixth, fifth, and second bits S<5:4>, and S<1> of the output data S<8:0> in the same manner. The XOR gate 321(4) of the fourth bit position BP(4) may perform an XOR operation on the fourth bit TD3<3> of the third transfer data TD3<8:0> and an inverted bit of the fourth bit A<3> of the second operand A<7:0> to generate and output a fourth bit S<3> of the output data S<8:0>. The XOR gate 321(3) of the third bit position BP(3) may perform an XOR operation on the third bit TD3<2> of the third transfer data TD3<8:0> and an inverted bit of the third bit A<2> of the second operand A<7:0> to generate and output a third bit S<2> of the output data S<8:0>. The XOR gate 321(1) of the first bit position BP(1) may perform an XOR operation on the first bit TD3<0> of the third transfer data TD3<8:0> and an inverted bit of the first bit A<0> of the second operand A<7:0> to generate and output a first bit S<0> of the output data S<8:0>.

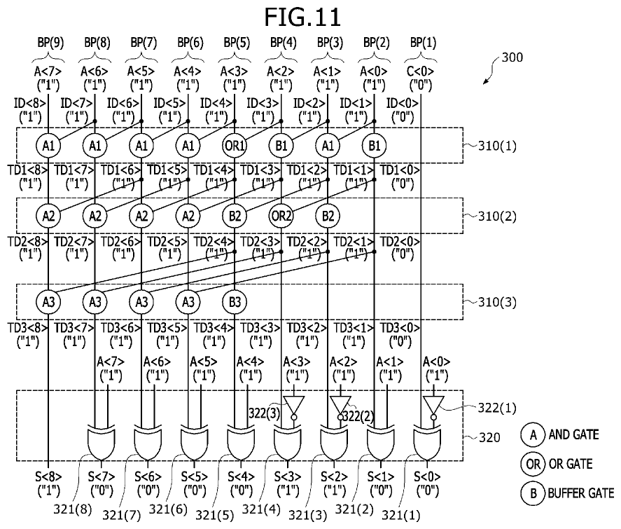

FIG. 11 is a diagram illustrating an addition operation of the “+13” fixed binary adder 300 of FIG. 10. In FIG. 11, the same reference numerals as in FIG. 10 denote the same elements. In the present example, a case in which the second operand A<7:0> is +255, that is, “1111 1111” will be taken as an example. It is assumed that the carrier data C<0> is “0”. Referring to FIG. 11, input data ID<8:0>, which is a binary stream of “1 1111 1110”, may be input to the first transfer logic stage 310(1). In the first transfer logic stage 310(1), the AND gate A1 of the ninth bit position BP(9) may perform an AND operation on the ninth bit ID<8>“1” of the input data ID<8:0> and the eighth bit ID<7>“1” of the input data ID<8:0> and may output “1” that is generated as a result of the AND operation as the ninth bit TD1<8> of the first transfer data TD1<8:0>. In the same manner, each of the AND gates A1s at the eighth to sixth bit positions BP(9)-BP(6) may output “1” as the eighth to sixth bits TD1<7:5> of the first transfer data TD1<8:0>, respectively. In addition, the AND gate A1 at the third bit position BP(3) may output “1” as the third bit TS1<2> of the first transfer data TD1<8:0> in the same manner. The OR gate OR1 at the fifth bit position BP(5) may perform an OR operation on the fifth bit ID<4>“1” of the input data ID<8:0> and the fourth bit ID<3>“1” of the input data ID<2> and may output “1” that is generated as a result of the OR operation as the fifth bit TD1<4> of the first transfer data TD1<8:0>. The buffer gates B1s at the fourth and second bits BP(4) and BP(2) may output the fourth and second bits ID<3> and ID<1>“1” of the input data ID<8:0> as it is as the fourth and second bits TD1<3> and TD1<1> of the first transfer data TD1<8:0>. The first bit TD1<0> of the first transfer data TD1<8:0> may be the same as the first bit ID<0>“0” of the input data ID<8:0>. As a result, the first transfer logic stage 310(1) may output a binary stream of “1 1111 1110” as the first transfer data TD1<8:0>.

The first transfer data TD1<8:0> of “1 1111 1110” may be input to the second transfer logic stage 310(2). In the second transfer logic stage 310(2), the AND gate A2 of the ninth bit position BP(9) may perform an AND operation on the ninth bit TD1<8>“1” of the first transfer data TD1<8:0> and the seventh bit TD1<6>“1” of the first transfer data TD1<8:0> and may output “1” that is generated as a result of the AND operation as the ninth bit TD2<8> of the second transfer data TD2<8:0>. In the same manner, the AND gates A2s at the eighth to sixth bit positions BP(9)-BP(6) may output “1” as the eighth to sixth bits TD2<7:5> of the second transfer data TD2<8:0>, respectively. The buffer gate B2 at the fifth bit position BP(5) may output the fifth bit TD1<4>“1” of the first transfer data TD1<8:0> as it is as the fifth bit TD2<3> of the second transfer data TD2<8:0>. The OR gate OR2 at the fourth bit position BP(4) of the second transfer logic stage 310(2) may perform an OR operation on the fourth bit TD1<3>“1” of the first transfer data TD1<8:0> and the second bit TD1<1>“1” of the first transfer data TD1<8:0> and may output “1” that is generated as a result of the OR operation as the fourth bit TD2<3> of the second transfer data TD2<8:0>. The buffer gate B2 of the third bit position BP(3) may output the third bit TD1<2>“1” of the first transfer data TD1<8:0> as it is as the third bit TD2<2> of the second transfer data TD2<8:0>. The second and first bits TD2<1:0> of the second transfer data TD2<8:0> may be the same as “1” and “0”, which are the second and first bits TD1<8:0> of the first transfer data TD1<8:0>, respectively. As a result, the second transfer logic stage 310(2) may output a binary stream of “1 1111 1110” as the second transfer data TD2<8:0>.

The second transfer data TD2<8:0> of “1 1111 1110” may be input to the third transfer logic stage 310(3). In the third transfer logic stage 310(3), the AND gate A3 at the ninth bit position BP(9) may perform an AND operation on the ninth bit TD2<8>“1” of the second transfer data TD2<8:0> and the fifth bit TD2<4>“1” of the second transfer data TD2<8:0> and may output “1” that is generated as a result of the AND operation as the ninth bit TD3<8> of third transfer data TD3<8:0>. In the same manner, the AND gates A3s at the eighth to sixth bit positions BP(9)-BP(6) may output “1” as the eighth to sixth bits TD3<7:5> of the third transfer data TD3<8:0>, respectively. The buffer gate B3 at the fifth bit position BP(5) may output the fifth bit TD2<4>“1” of the second transfer data TD2<8:0> as it is as the fifth bit TD3<4> of the third transfer data TD3<8:0>. The fourth to first bits TD3<3:0> of the third transfer data TD3<8:0> may be the same as “1110”, which are the fourth to first bits TD2<3:0> of the second transfer data TD2<8:0> respectively. As a result, the third transfer logic stage 310(3) may output a binary stream of “1 1111 1110” as third transfer data TD3<8:0>.

The third transfer data TD3<8:0> of “1 1111 1110” and the second operand A<7:0> of “1111 1111” may be input to the summation logic stage 320. The ninth bit TD3<8>“1” of the third transfer data TD3<8:0> that is input at the ninth bit position BP(9) of the summation logic stage 320 may be output as the ninth bit S<8> of the output data S<8:0>. The XOR gate 321(8) of the eighth bit position BP(8) may perform an XOR operation on the eighth bit TD3<7>“1” of the third transfer data TD3<8:0> and the eighth bit A<7>“1” of the second operand A<7:0> to output “0” as the eighth bit S<7> of the output data S<8:0>. In the same manner, the XOR gates 321(7)-321(5), and 321(2) at the seventh to fifth, and second bit positions BP(7)-BP(5), and BP(2) may output “0” as the seventh to fifth, and second bits S<6:4>, and S<1> of the output data S<8:0>, respectively. The XOR gate 322(4) at the fourth bit position BP(4) may perform an XOR operation on the fourth bit TD3<3>“1” of the third transfer data TD3<8:0> and an inverted bit of the fourth bit A<3>“1” of the second operand A<7:0>, that is “0”, and may output “1” as the fourth bit A<3> of the output data S<8:0>. The XOR gate 322(3) of the third bit position BP(3) may perform an XOR operation on the third bit TD3<2>“1” of the third transfer data TD3<8:0> and an inverted bit of the third bit A<2>“1” of the second operand A<7:0>, that is “0” and may output “1” as the third bit S<2> of the output data S<8:0>. As a result, the summation logic stage 320 may output “1 0000 1100” as result data S<8:0> that is obtained by adding “1111 1111” as the second operand A<7:0> to the fixed value “0000 1101” as the first operand.

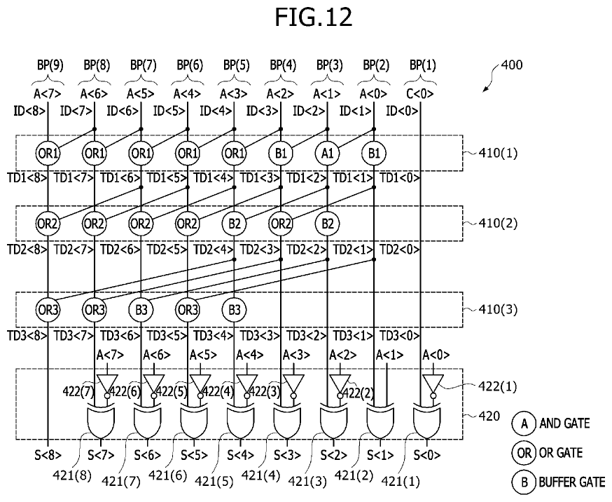

FIG. 12 is a diagram illustrating a “−3” fixed binary adder 400 according to another embodiment of the present disclosure. The “−3” fixed binary adder 400, according to the present embodiment, may perform an addition operation on a first operand having “−3” as an 8-bit fixed value and an 8-bit second operand A<7:0>. Because the first operand is a negative number as “−0000 0011”, logic gates in the “−3” fixed binary adder 400 may be set based on the 2's complement of the first operand, that is, “1111 1101”. Accordingly, the “−3” fixed binary adder 400 may correspond to a case in which “N” is 8 (“M” is 3) and “L” is 7 in FIGS. 2 to 7. Referring to FIG. 12, the “−3” fixed binary adder 400 may have ninth to first bit positions BP(9)-BP(1) corresponding to each bit of input data ID<8:0>. The ninth to first bit positions BP(9)-BP(1) may also correspond to each bit of the transfer data TD<8:0> that is output from each transfer logic stage and may also correspond to each bit of output data S<8:0>. The input data ID<8:0> may be composed of an 8-bit second operand A<7:0> and 1-bit carry-in data C<0>. The carry-in data C<0> may have a fixed value of “0”. The “−3” fixed binary adder 400 may perform an addition operation of adding 2's complement of “−3”, that is, “1111 1101” to the second operand A<7:0> to generate and output 9-bit output data S<8:0>. The “−3” fixed binary adder 400 may include three transfer logic stages 410(1)-410(3) and a summation logic stage 420.

The first transfer logic stage 410(1) may include five OR gates OR1s, one AND gate A1, and two buffer gate Bis. The OR gates OR1s may be disposed at the ninth to fifth bit positions BP(9)-BP(5) of the first transfer logic stage 410(1). The AND gate A1 may be disposed at the third bit position BP(3). The buffer gates B1s may be disposed at the fourth and second bit positions BP(4) and BP(2). The first transfer logic stage 410(1) might not have a logic gate at the first bit position BP(1). The OR gate OR1 that is disposed at the ninth bit position BP(9) of the first transfer logic stage 410(1) may perform an OR operation on the ninth bit ID<8> and the eighth bit ID<7> of the input data ID<8:0> to generate and output a ninth bit TD1<8> of first transfer data TD1<8:0>. In the same manner, the OR gates OR1s that are disposed at the eighth to fifth bit positions BP(8)-BP(5) of the first transfer logic stage 410(1) may generate and output eighth to fifth bits TD1<7:4> of the first transfer data TD1<8:0>. The buffer gate B1 that is disposed at the fourth bit position BP(4) of the first transfer logic stage 410(1) may output the fourth bit ID<3> of the input data ID<8:0> as it is as a fourth bit TD1<3> of the first transfer data TD1<8:0>. The AND gate A1 that is disposed at the third bit position BP(3) of the first transfer logic stage 410(1) may perform an AND operation on the third bit ID<2> and the second bit ID<1> of the input data ID<8:0> to generate and output a third bit TD1<2> of the first transfer data TD1<8:0>. The buffer gate B1 that is disposed at the second bit position BP(2) of the first transfer logic stage 410(1) may output the second bit ID<1> of the input data ID<8:0> as it is as a second bit TD1<1> of the first transfer data TD1<8:0>. A first bit TD1<0> of the first transfer data TD1<8:0> may have the same value as the first bit ID<0> of the input data ID<8:0>, that is, the carry-in data C<0>.

The second transfer logic stage 410(2) may include five OR gates OR2s and two buffer gate B2s. The OR gates OR2s may be disposed at the ninth to sixth, and fourth bit positions BP(9)-BP(6) and BP(4) of the second transfer logic stage 410(2). The buffer gates B2s may be disposed at the fifth and third bit positions BP(5) and BP(3) of the second transfer logic stage 410(2). The second transfer logic stage 410(2) might not have logic gates at the second bit position BP(2) and the first bit position BP(1). The OR gate OR2 that is disposed at the ninth bit position BP(9) of the second transfer logic stage 410(2) may perform an OR operation on the ninth bit TD1<8> and the seventh bit TD1<6> of the first transfer data TD1<8:0> to generate and output a ninth bit TD2<8> of second transfer data TD2<8:0>. In the same manner, the OR gates OR2s that are disposed at the eighth to sixth, and fourth bit positions BP(8)-BP(6), and BP(4) of the second transfer logic stage 410(2) may generate and output eighth to sixth, and fourth bits TD2<7:5> and TD2<3> of the second transfer data TD2<8:0>. The buffer gates B2s that are disposed at the fifth and third bit positions BP(5) and BP(3) of the second transfer logic stage 410(2) may output the fifth bit TD1<4> and the third bit TD1<2> of the first transfer data TD1<8:0> as they are as a fifth bit TD2<4> and a third bit TD2<2> of the second transfer data TD2<8:0>. A second bit TD2<1> and a first bit TD2<0> of the second transfer data TD2<8:0> may have the same values as the second bit TD1<1> and the first bit TD1<0> of the first transfer data TD1<8:0>, respectively.

The third transfer logic stage 410(3) may include three OR gates OR3s and two buffer gate B3s. The OR gates OR3s may be disposed at the ninth, eighth, and sixth bit positions BP(9), BP(8), and BP(6) of the third transfer logic stage 410(2). The buffer gates B3s may be disposed at the seventh and fifth bit positions BP(7) and BP(5) of the third transfer logic stage 410(3). The third transfer logic stage 410(3) might not have logic gates at the fourth to first bit positions BP(4)-BP(1). The OR gate OR3 that is disposed at the ninth bit position BP(9) of the third transfer logic stage 410(3) may perform an OR operation on the ninth bit TD2<8> and the fifth bit TD2<4> of the second transfer data TD2<8:0> to generate and output a ninth bit TD3<8> of third transfer data TD3<8:0>. In the same manner, the OR gates OR3s that are disposed at the eighth and sixth bit positions BP(8) and BP(6) of the third transfer logic stage 410(3) may generate and output eighth and sixth bits TD3<7> and TD3<5> of the third transfer data TD3<8:0>, respectively. The buffer gate B3 that is disposed at the seventh bit position BP(7) of the third transfer logic stage 410(3) may output the seventh bit TD2<6> of the second transfer data TD2<8:0> as it is as a seventh bit TD3<6> of the third transfer data TD3<8:0>. The buffer gate B3 that is disposed at the fifth bit position BP(5) of the third transfer logic stage 410(3) may output the fifth bit TD2<4> of the second transfer data TD2<8:0> as it is as a fifth bit TD3<4> of the third transfer data TD3<8:0>. A fourth bit TD3<3>, a third bit TD3<2>, a second bit TD3<1>, and a first bit TD3<0> of the third transfer data TD3<8:0> may have the same values as the fourth bit TD2<3>, the third bit TD2<2>, the second bit TD2<1>, and the first bit TD2<0> of the second transfer data TD2<8:0>, respectively.

The summation logic stage 420 may receive the third transfer data TD3<8:0> that is output from the third transfer logic stage 410(3) and a second operand A<7:0>. Because the first operand is “1111 1101”, which is 2's complement of “3”, an XOR gate 421(2) that is disposed at the second bit position BP(2) of the eight XOR gates 421(8)-421(1) of the summing logic stage 420 may belong to a first group. On the other hand, the XOR gates 421(8)-421(3) and 421(1), among the eight XOR gates 421(8)-421(1) of the summation logic stage 420, disposed at the eighth to third and first bit positions BP(8)-BP(3) and BP(1), may belong to a second group. The XOR gate 421(2) of the first group may receive the second bit TD3<1> of the third transfer data TD3<8:0> through one input terminal and receive the second bit A<1> of the second operand A<7:0> through the other input terminal. The XOR gates 421(8)-421(3), and 421(1) of the second group may receive the eighth to third, and first bits TD3<7:2>, and TD3<0> of the third transfer data TD3<8:0> through one input terminal, respectively. The eighth to third, and first bits A<7:2> and A<0> of the second operand A<7:0> may be input to NOT gates 422(7)-422(1) that are disposed at the eighth to third, and first bit positions BP(8)-BP(3), and BP(1). The NOT gates 422(7)-422(1) may transmit inverted bits of the eighth to third, and first bits A<7:2> and A<0> of the second operand A<7:0> to the other input terminals of the XOR gates 421(8)-421(3), and 421(1) of the second group, respectively.

The ninth bit TD3<8> of the third transfer data TD3<8:0> that is transmitted to the ninth bit position BP(9) of the summation logic stage 420 may be output from the summation logic stage 420 as it is as a ninth bit S<8> of the output data S<8:0>. The XOR gate 421(8) of the eighth bit position BP(8) may perform an XOR operation on the eighth bit TD3<7> of the third transfer data TD3<8:0> and an inverted bit of the eighth bit A<7> of the second operand A<7:0> to generate and output an eighth bit S<7> of the output data S<8:0>. The XOR gate 421(7) of the seventh bit position BP(7) may perform an XOR operation on the seventh bit TD3<6> of the third transfer data TD3<8:0> and an inverted bit of the seventh bit A<6> of the second operand A<7:0> to generate and output a seventh bit S<6> of the output data S<8:0>. The XOR gates 421(6)-421(3), and 421(1) that are disposed at the sixth to third, and first bit positions BP(6)-BP(3), and BP(1) may generate and output sixth to third, and first bits S<5:2>, and S<0> of the output data S<8:0> in the same manner.

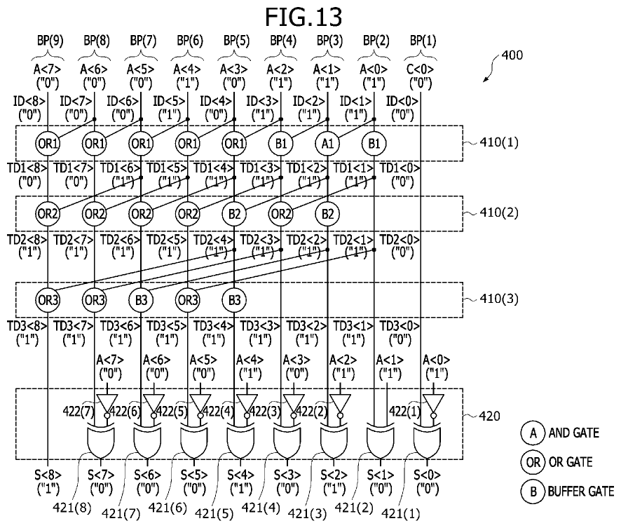

FIG. 13 is a diagram illustrating an example of an addition operation of the “−3” fixed binary adder 400 of FIG. 12. In FIG. 13, the same reference numerals as in FIG. 12 denote the same components. In this example, a case in which the second operand A<7:0> is +20, that is, “0001 0111” will be taken as an example. That is, the “−3” fixed binary adder 400 may perform an operation of “20-3”. It is assumed that the carry-in data C<0> is “0”. Referring to FIG. 13, input data ID<8:0>, which is a binary stream of “0 0010 1110”, may be input to the first transfer logic stage 410(1). The OR gate OR1 of the ninth bit position BP(9) in the first transfer logic stage 410(1) may perform an OR operation on the ninth bit ID<8>“0” of the input data ID<8:0> and the eighth bit ID<7>“0” of the input data ID<8:0> and may output “0” that is generated as a result of the OR operation as the ninth bit TD1<8> of the first transfer data TD1<8:0>. By performing OR operations in the same manner, the OR gates OR1s of the eighth to fifth bit positions BP(8)-BP(5) may output “O”, “1”, “1”, “1” as the eighth to fifth bits TD1<7:5> of the first transfer data TD1<8:0>, respectively. The buffer gate B1 of the fourth bit position BP(4) may output the fourth bit ID<3>“1” of the input data ID<8:0> as it is as the fourth bit TD1<3> of the first transfer data TD1<8:0>. The AND gate A1 of the third bit position BP(3) may perform an AND operation on the third bit ID<2>“1” of the input data ID<8:0> and the second bit ID<1>“1” of the input data ID<8:0> and may output “1” that is generated as a result of the AND operation as the third bit TD1<2> of the first transfer data TD1<8:0>. The buffer gate B1 of the second bit position BP(2) may output the second bit ID<1>“1” of the input data ID<8:0> as it is as the second bit TD1<1> of the first transfer data TD1<8:0>. The first bit TD1<0> of the first transfer data TD1<8:0> may be the same as the first bit ID<0>“0” of the input data ID<8:0>. As a result, the first transfer logic stage 410(1) may output a binary stream of “0 0111 1110” as the first transfer data TD1<8:0>.

The first transfer data TD1<8:0> of “0 0111 1110” may be input to the second transfer logic stage 410(2). In the second transfer logic stage 410(2), the OR gate OR2 of the ninth bit position BP(9) may perform an OR operation on the ninth bit TD1<8>“0” of the first transfer data TD1<8:0> and the seventh bit TD1<6>“1” of the first transfer data TD1<8:0> and may output “1” that is generated as a result of the OR operation as the ninth bit TD2<8> of the second transfer data TD2<8:0>. By performing OR operations in the same manner, the OR gates OR2s of the eighth to sixth bit positions BP(8)-BP(6) may output “111” as the eighth to sixth bits TD2<7:5> of the second transfer data TD2<8:0>, respectively. In addition, by performing an OR operation in the same manner, the OR gate OR2 of the fourth bit position BP(4) may output “1” as the fourth bit TD2<3> of the second transfer data TD2<8:0>. The buffer gate B2 at the fifth bit position BP(5) may output the fifth bit TD1<4>“1” of the first transfer data TD1<8:0>, as it is as the fifth bit TD2<4> of the second transfer data TD2<8:0>. The buffer gate B2 at the third bit position BP(3) may output the third bit TD1<2>“1” of the first transfer data TD1<8:0> as it is as the third bit TD2<2> of the second transfer data TD2<8:0>. The second and first bits TD2<1:0> of the second transfer data TD2<8:0> may be the same as the second and first bits TD1<1:0>“1” and “0” of the first transfer data TD1<8:0>, respectively. As a result, the second transfer logic stage 410(2) may output the binary stream of “1 1111 1110” as the second transfer data TD2<8:0>.

The second transfer data TD2<8:0> of “1 1111 1110” may be input to the third transfer logic stage 410(3). In the third transfer logic stage 410(3), the OR gate OR3 of the ninth bit position BP(9) may perform an OR operation on the ninth bit TD2<8>“0” of the second transfer data TD2<8:0> and the fifth bit TD2<4>“1” of the second transfer data TD2<8:0> and may output “1” that is generated as a result of the OR operation as the ninth bit TD3<8> of the third transfer data TD3<8:0>. By performing OR operations in the same manner, the OR gates OR3s of the eighth and sixth bit positions BP(8) and BP(6) may output “1” as the eighth and sixth bits TD3<7> and TD3<5> of the third transfer data TD3<8:0>. The buffer gate B3 in the seventh bit position BP(7) may output the seventh bit TD2<6>“1” of the second transfer data TD2<8:0> as it is as the seventh bit TD3<6> of the third transfer data TD3<8:0>. The buffer gate B3 at the fifth bit position BP(5) may output the fifth bit TD2<4>“1” of the second transfer data TD2<8:0> as it is as the fifth bit TD3<4> of the third transfer data TD3<8:0>. The fourth to first bits TD2<3:0> of the third transfer data TD3<8:0> may be the same as the fourth to first bits TD2<3:0>“1110” of the second transfer data TD2<8:0>, respectively. As a result, the third transfer logic stage 410(3) may output the binary stream of “1 1111 1110” as the third transfer data TD3<8:0>.

The third transfer data TD3<8:0> of “1 1111 1110” and the second operand A<7:0> of “0001 1011” may be input to the summation logic stage 420. The ninth bit TD3<8>“1” of the third transfer data TD3<8:0> that is input from the ninth bit position BP(9) of the summation logic stage 420 may be output as the ninth bit S<8> of the output data S<8:0>. The XOR gate 421(8) of the eighth bit position BP(8) may perform an XOR operation on the eighth bit TD3<7>“1” of the third transfer data TD3<8:0> and an inverted bit “1” of the eighth bit A<7>“0” of the second operand A<7:0> and may output “0” as the eighth bit S<7> of the output data S<8:0>. In the same manner, the remaining XOR gates 421(7)-421(1) may output “0010100” as the seventh to first bits S<6:0> of the output data S<8:0>, respectively. As a result, the summation logic stage 420 may output “1 0001 0100” as the result data S<8:0> that is obtained by adding “0001 0111” as the second operand A<7:0> to “1111 1101”, which is the 2's complement of “3” as the first operand. In the “−3” fixed binary adder 400, because the 2's complement of “3” is used as the first operand, the method of extracting the summation data may be different depending on whether carry occurs or not. As in this example, when the ninth bit S<8> of the output data is “1”, that is, when carry has occurred, “00010100”, which is the eighth to first bits S<7:0> of the output data S<8:0>, may become the summation data.

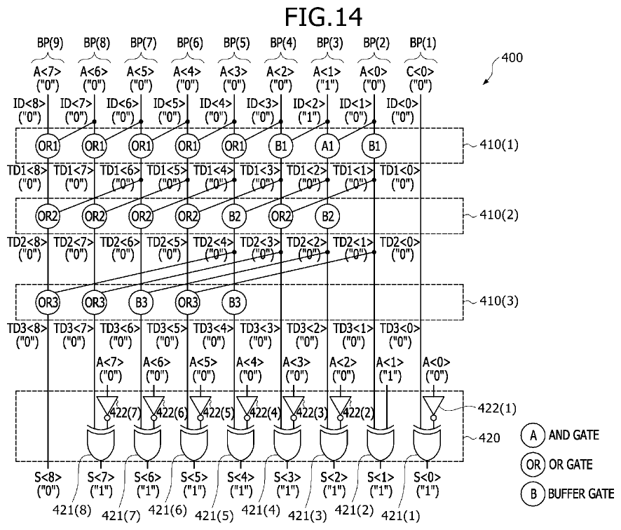

FIG. 14 is a diagram illustrating another example of an addition operation of the “−3” fixed binary adder 400 of FIG. 12. In FIG. 14, the same reference numerals as in FIG. 12 denote the same components. In this example, a case in which the second operand A<7:0> is +2, that is, “0000 0010” will be taken as an example. That is, the “−3” fixed binary adder 400 may perform an operation of “2-3”. It is assumed that the carry-in data C<0> is “0”. Referring to FIG. 14, input data ID<8:0>, which is a binary stream of “0 0000 0010”, may be input to the first transfer logic stage 410(1). In the same manner as described with reference to FIG. 13, the first transfer logic stage 410(1) may output “0 0000 0000” as the first transfer data TD1<8:0>. The second transfer logic stage 410(2) may output “0 0000 0000” as the second transfer data TD2<8:0>. In addition, the third transfer logic stage 410(3) may output “0 0000 0000” as the third transfer data TD3<8:0>. The summation logic stage 420 may output “0 1111 1111” as the output data S<8:0>. When the ninth bit S<8> of the output data S<8:0> is “0”, that is, when no carry occurs, the 2's complement of the eighth to first bits S<7:0> of the output data S<8:0> may become the summation data, and a sign may become negative. In this example, as the operation result of 2(“0000 0010”)-3(“0000 0011), “−0000 0001” with a negative sign attached to 2's complement of “1111 1111”, which is the eighth to first bits (S<7:0>) of the output data (S<8:0>), may become the summation data.

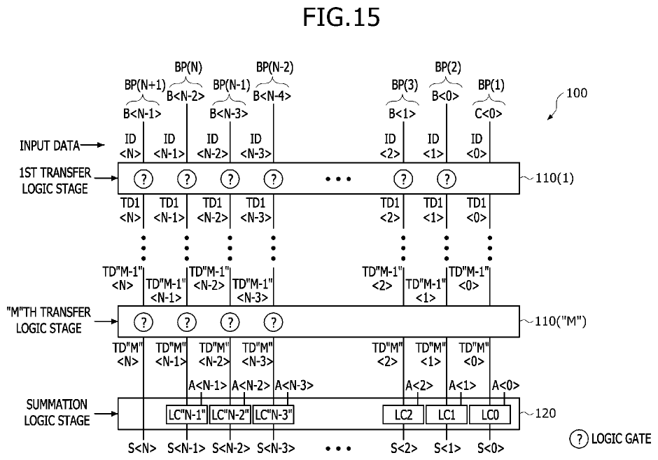

FIG. 15 is a diagram illustrating a method of designing a fixed binary adder 100 according to an example of the present disclosure. Hereinafter, a case of designing a fixed binary adder that generates output data of “N+1” bits S<N:0> by adding a first operand having an “N”-bit fixed binary value to an “N”-bit second operand A<N−1:0> will be taken as an example. In FIG. 15, the same reference numerals as in FIG. 2 denote the same components. Referring to FIG. 15, first, “N+1” bit positions BP(N+1)-BP(1) may be set. Each of the “N+1” bit positions BP(N+1)-BP(1) may correspond to each of the “N” bits of the first operand B<N−1:0> and the 1-bit carry-in data C<0>. Specifically, the first bit position BP(1) may correspond to the carry-in data C<0>. The carry-in data C<0> may have a fixed value of “0”. The “N+1”^{th} to second bit positions BP(N+1)-BP(2) may correspond to the bits of the N-bit first operand B<N−1:0>, respectively. That is, the “N+1”^{th} bit position BP(N+1) may correspond to the “N”^{th} bit B<1-1> of the “N”-bit first operand B<N−1:0>. In addition, the second bit position BP(2) may correspond to the first bit B<0> of the “N”-bit first operand B<N−1:0>.

Next, a plurality of transfer logic stages 110(1)-110(M) may be set. The number of transfer logic stages 110(1)-110(M) may be set to “M”. Since the fixed binary adder 100 performs “N”-bit addition operation and “N” is 2^{M}, “M” may be set to “log₂M”. In an example, when the fixed binary adder 100 performs a “4” (=2²)-bit addition operation, the number of the transfer logic stages may be set to 2. When the fixed binary adder 100 performs an “8” (=2³)-bit addition operation, the number of the transfer logic stages may be set to 3. In addition, when the fixed binary adder 100 performs a “16” (=2⁴)-bit addition operation, the number of the transfer logic stages may be set to 4.

Next, logic gates may be arranged in each of the transfer logic stages 110(1)-110(M). The number of the logic gates that are arranged in each of the transfer logic stages 110(1)-110(M) may be set to “N+1−2^{M-1}”. In the case of the first transfer logic stage 110(1), because “M” is 1, “N” logic gates may be arranged. In the case of the second transfer logic stage 110(2), because “M” is 2, “N−1” logic gates may be arranged. In the case of the third transfer logic stage 110(3), because “M” is 3, “N−3” logic gates may be arranged. The logic gates may be sequentially arranged in a direction from the uppermost bit position of the transfer logic stage, that is, the “N+1”^{th} bit position BP(N+1) to the lower bit position. According to a rule, the logic gates may be one of an AND gate, an OR gate, and a buffer gate. A process in which the logic gates are selected will be described below.

Next, “N” logic circuits LC“N−1”-LC0 may be arranged in the summation logic stage 120. Each of the “N” logic circuits LC“N−1”-LC0 may be arranged in the remaining “N”^{th} to first bit positions BP(N)-BP(1), among the “N+1” bit positions BP(N+1)-BP(1) of the summation logic stage 120, except for the uppermost bit position BP(N+1). The logic circuits LC“N−1”-LC0 may be configured to receive the “N”^{th} to first bits TD“M”<N−1:0> of the “M”^{th} transfer data TD“M”<N:0> that is transmitted from the lowest transfer logic stage, that is, the “M”^{th} transfer logic stage 110(M) and the second operand A<N−1:0>. The logic circuits LC“N−1”-LC0 may be configured to output the “N”^{th} to first bits S<N−1:0> of the output data S<N:0>. Each of the logic circuits LC“N−1”-LC0 may be configured with only XOR gates or may be configured with XOR gates and NOT gates.

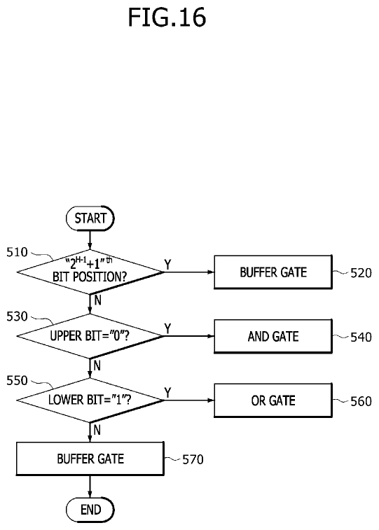

FIG. 16 is a diagram illustrating a method of selecting logic gates in each of transfer logic stages in a method of designing a fixed binary adder 100 according to an embodiment of the present disclosure. Referring to FIG. 16, in step 510, it may be determined whether the bit position BP at which the logic gate is to be arranged (hereinafter, referred to as “target bit position”) is the “2^{H-1}+1”^{th} bit position BP(2^{H-1}+1). Here, “H” represents the order of the transfer logic stages, so “H” corresponds to one of 1, . . . , and “M”. That is, in the case of a first transfer logic stage, because “H” is 1, the “2^{H-1}+1”^{th} bit position BP(2^{H-1}+1) may be the second bit position BP(2). In the case of the second transfer logic stage, because “H” is 2, the “2^{H-1}+1”^{th} bit position BP(2^{H-1}+1) may be the third bit position BP(3). In the case of the “M”^{th} transfer logic stage, because “H” is “M”, the “2^{H-1}+1”^{th} bit position BP(2^{H-1}+1) may be the “2^{M-1}+1”^{th} bit position BP(2^{M-1}+1).

In the determination of the step 510, if the target bit position is the “2^{H-1}+1”^{th} bit position BP(2^{H-1}+1), a buffer gate may be disposed at the target bit position in step 520. On the other hand, if the target bit position is not the “2^{H-1}+1”^{th} bit position BP(2^{H-1}+1), it may be determined whether the upper bit of the two input bits input to the logic gate is “0” in step 530. If the upper bit is “0”, an AND gate is arranged at the target bit position in step 540. If the upper bit, among two input bits input to the logic gate in step 550, is not “0”, that is, if the upper bit is “1”, it may be determined whether the lower bit is “1”. If the lower bit is “1”, an OR gate may be arranged at the target bit position in step 560. If the lower bit is not “1”, the buffer gate may be arranged at the target bit position in step 570.

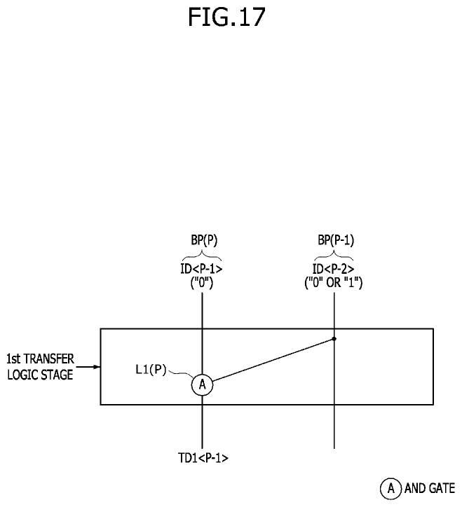

FIGS. 17 to 20 are diagrams illustrating a method of configuring a first transfer logic stage in a method of designing a fixed binary adder 100 according to an example of the present disclosure. Hereinafter, a process of arranging a logic gate at a “P”^{th} bit position BP(P) of a first transfer logic stage will be taken as an example. The “P” may represent a natural number that is equal to or less than “N+1” and greater than “2^{H-1}+1”. In FIGS. 17 to 20, the same reference numerals denote the same elements. As shown in FIGS. 17 to 19, when the “P”^{th} bit position BP(P), which is the target bit position of the first transfer logic stage, is not the “2^{H-1}+”^{th} bit position, that is, the second bit position BP(2), the buffer gate according to the step 520 of FIG. 16 may be excluded from logic gate selection.

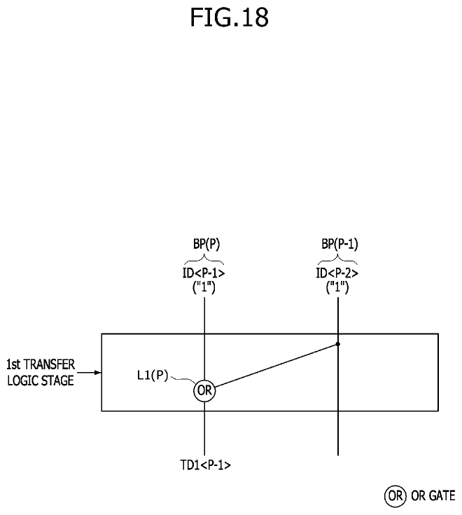

First, as shown in FIG. 17, when the “P”^{th} bit ID<P−1> of the input data ID<N:0> (that is, “P−1”^{th} bit ID<P−2> of the first operand B<N:0>) is “0”, as the logic gate L1(P), an AND gate may be selected according to the step 540 of FIG. 16, regardless of the “P−1”^{th} bit ID<P−2>, which is 1 bit lower than the “P”^{th} bit ID<P−1>. The AND gate that is disposed at the “P”^{th} bit position BP(P) may perform an AND operation on the “P”^{th} bit ID<P−1> and the “P−1”^{th} bit ID<P−2> of the input data ID<N:0> and output an AND operation result, that is, “0” as a “P”^{th} bit TD1<P−1> of first transfer data TD1<N:0>. Next, as shown in FIG. 18, when the “P−1”^{th} bit ID<P−2> of the input data ID<N:0> is “1”, selection for the logic gate L1(P) may be performed according to the “P−1”^{th} bit ID<P−2>, which is 1 bit lower than the “P”^{th} bit ID<P−1>. In this example, since the “P−1”^{th} bit (ID<P−2>) of the input data ID<N:0> is “1”, an OR gate may be selected as the logic gate L1(P) according to the step 560 of FIG. 16. The OR gate that is disposed at the “P”^{th} bit position BP(P) may perform an OR operation on the “P”^{th} bit ID<P−1> and the “P−1”^{th} bit ID<P−2> of the input data ID<N:0> and output an OR operation result, that is, “1” as the “P”^{th} bit TD1<P−1> of first transfer data TD1<N:0>.

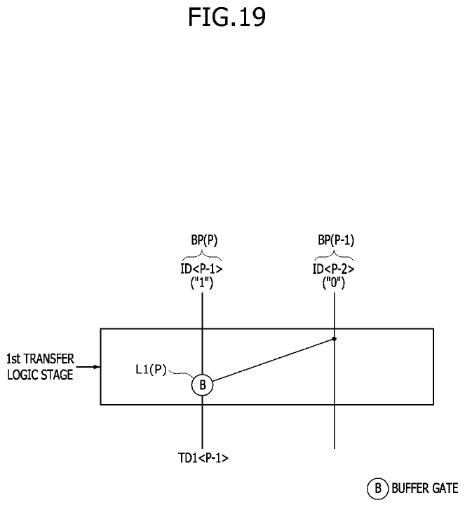

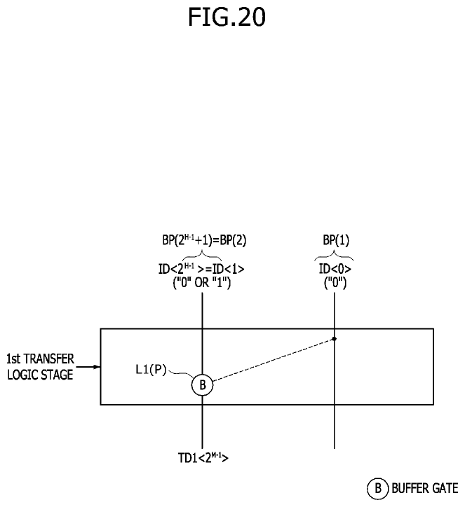

Next, as shown in FIG. 19, when the “P”^{th} bit ID<P−1> of the input data ID<N:0> is “1” and the “P−1”^{th} bit ID<P−2> of the input data ID<N:0> is “0”, a buffer gate may be selected as the logic gate L1 (P) according to the step 570 of FIG. 16. The buffer gate that is disposed at the “P”^{th} bit position BP(P) may output the “P”^{th} bit ID<P−1>, that is, “1” as the “P”^{th} bit TD1<P−1> of first transfer data TD1<N:0>. Next, as shown in FIG. 20, when the target bit position is the second bit position BP(2) corresponding to the “2^{H-1}+1”^{th} bit position BP(2^{H-1}+1) of the first transfer logic stage, a buffer gate B may be selected as the logic gate L1 (P) according to the step 520 of FIG. 16 regardless of the “2^{H-1}+1”^{th} bit ID<2^{H-1}> of the input data ID<8:0>, that is, the second bit ID<1>. When the buffer gate B according to step 520 of FIG. 16 is selected, as indicated by the dotted line in the drawing, connection between the buffer gate B of the second bit position BP(2) and the first bit position BP(1) may be removed. The buffer gate B that is disposed at the second bit position BP(2) of the first transfer logic stage may output the second bit ID<1> of the input data ID<N:0> as a second bit TD2<1> of second transfer data TD2<N:0>.

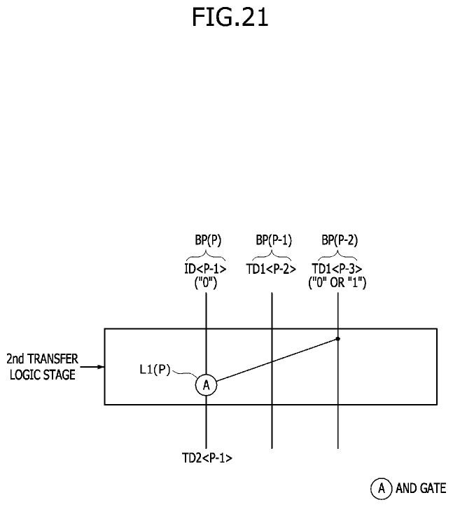

FIGS. 21 to 24 are diagrams illustrating a method of configuring a second transfer logic stage in a method of designing a fixed binary adder 100 according to an example of the present disclosure. Hereinafter, a process of arranging logic gates at the “P”^{th} bit position BP(P) of the first transfer logic stage will be taken as an example. “P” represents a natural number equal to or less than “N+1” and greater than “2^{H-1}+1”. In FIGS. 21 to 24, the same reference numerals denote the same components. As shown in FIGS. 21 to 23, when the “P”^{th} bit position BP(P), which is a target bit position of the first transfer logic stage, is not the “2^{H-1}+1”^{th} bit position, that is, the third bit position BP(3), the buffer gate according to the step 520 of FIG. 16 may be excluded from logic gate selection.

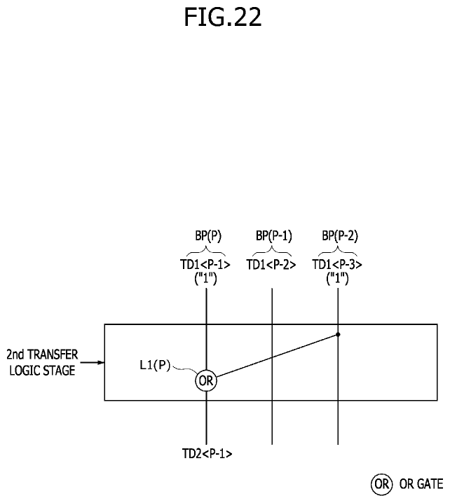

First, as shown in FIG. 21, a “P”^{th} bit TD1<P−1> of the first transfer data TD1<N:0> transmitted from the first transfer logic stage at the “P”^{th} bit position BP(P) is “0”, an AND gate may be selected as the logic gate L1(P) according to the step 540 of FIG. 16 regardless of the “P−2”^{th} bit TD1<P−3>, which is 2 bits lower than the “P”^{th} bit TD1<P−1>. The AND gate that is disposed at the “P”^{th} bit position BP(P) may perform an AND operation on the “P”^{th} bit TD1<P−1> and the “P−2”^{th} bit TD1<P−3> of the first transfer data TD1<N:0> and output a result of the AND operation, that is, “0” as a “P”^{th} bit TD2<P−1> of the second transfer data TD2<N:0>. Next, as shown in FIG. 22, when the “P”^{th} bit TD1<P−1> of the first transfer data TD1<N:0> is “1”, selection for the logic gate L1(P) may be performed according to the “P−2”^{th} bit TD1<P−3>, which is 2 bits lower than the “P”^{th} bit TD1<P−1>. In this example, because the “P−2”^{th} bit TD1<P−3> of the first transfer data TD1<N:0> is “1”, an OR gate may be selected as the logic gate L1(P) according to the step 560 of FIG. 16. The OR gate that is disposed at the “P”^{th} bit position BP(P) may perform an OR operation on the “P”^{th} bit TD1<P−1> and the “P−2”^{th} bit TD1<P−3> of the first transfer data TD1<N:0> and output a result of the OR operation, that is, “1” as a “P”^{th} bit TD2<P−1> of the second transfer data TD2<N:0>.

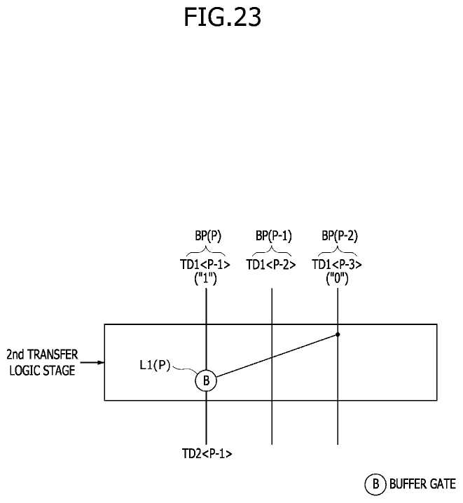

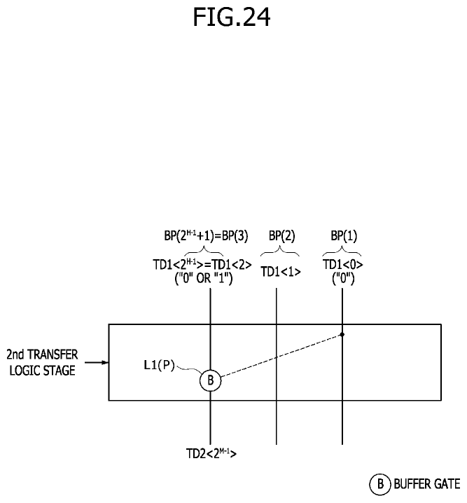

Next, as shown in FIG. 23, the “P”^{th} bit TD1<P−1> of the first transfer data TD1<N:0> is “1” and the “P−2”^{th} bit TD1<P−3> is “0”, a buffer gate may be selected as the logic gate L1(P) according to the step 570 of FIG. 16. The buffer gate that is disposed at the “P”^{th} bit position BP(P) may output the “P”^{th} bit TD1<P−1> of the first transfer data TD1<N:0>, that is, “1” as a “P”^{th} bit TD2<P−1> of the second transfer data TD2<N:0>. Next, as shown in FIG. 24, when the target bit position is the third bit position BP(3) corresponding to the “2^{H-1}+1”^{th} bit position BP(2^{H-1}+1), a buffer gate B according to the step 520 of FIG. 16 may be selected as the logic gate L1(P) regardless of the “2^{H-1}+1”^{th} bit TD1<2^{H-1}> of the first transfer data TD1<8:0>, that is, the third bit TD<2> of the first transfer data TD1<8:0>. If the buffer gate B according to the step 520 of FIG. 16 is selected, connection between the buffer gate B at the third bit position BP(3) and the first bit position BP(1) may be removed, as indicated by the dotted line in FIG. 24. The buffer gate B that is disposed at the third bit position BP(3) of the second transfer logic stage may output the third bit TD1<2> of the first transfer data TD1<N:0> as A third bit TD2<2> of the second transfer data TD2<N:0>.

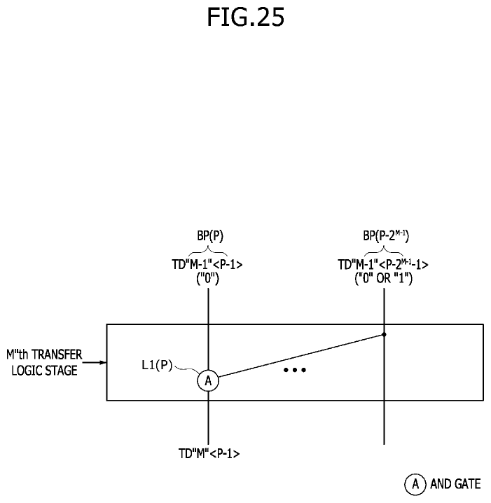

FIGS. 25 to 28 are diagrams illustrating a method of configuring an “M”^{th} transfer logic stage in a method of designing a fixed binary adder 100 according to an example of the present disclosure. Hereinafter, a process of arranging a logic gate at a “P”^{th} bit position BP(P) of the “M”^{th} transfer logic stage will be taken as an example. The “P” may represent a natural number equal to or less than “N+1” and greater than “2^{H-1}+1”. In FIGS. 25 to 28, the same reference numerals denote the same elements. As illustrated in FIGS. to 27, when the “P”^{th} bit position BP(P), which is the target bit position of the “M”^{th} transfer logic stage is not the the “2^{M-1}+1”^{th} bit position BP(2^{M-1}+1), the buffer gate according to the step 520 of FIG. 16 may be excluded from the logic gate selection.

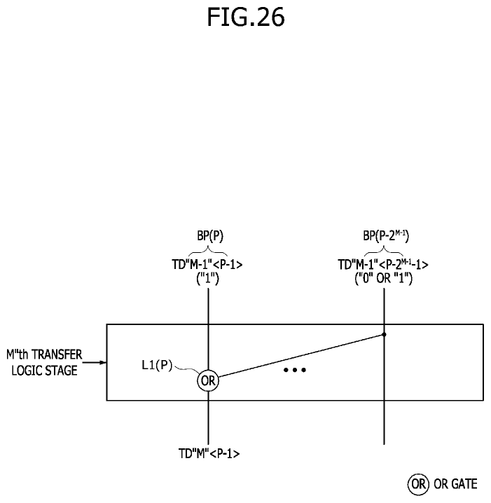

First, as illustrated in FIG. 25, when the “P”^{th} bit TD“M−1”<P−1> of the “M−1”^{th} transfer data TD“M−1”<N:0> transmitted from the “M−1”^{th} transfer logic stage at the “P”^{th} bit position BP(P) is “0”, an AND gate may be selected as the logic gate L1(P) according to the step 540 of FIG. 16 regardless of the “P−2^{M-1}”^{th} bit TD“M−1”<P−2^{M-1}−1>, which is “2^{M-1}” bits lower than the “P”^{th} bit TD“M−1”<P−1>. The AND gate that is disposed at the “P”^{th} bit position BP(P) may perform an AND operation on the “P”^{th} bit TD“M−1”<P−1> and the “P−2^{M-1}”^{th} bit TD“M−1”<P−2^{M-1}−1> of the “M−1”^{th} transfer data TD“M−1”<N:0> and output a result of the AND operation, that is, “0” as a “P”^{th} bit TD“M”<P−1> of the second transfer data TD“M”<N:0>. Next, as shown in FIG. 26, when the “P”^{th} bit TD“M−1”<P−1> of the “M−1”^{th} transfer data TD“M−1”<N:0> is “1”, selection for the logic gate L1(P) may be performed according to the “P−2^{M-1}”^{th} bit TD“M−1”<P−2^{M-1}−1>, which is “2^{M-1}” lower than the “P”^{th} bit TD“M−1”<P−1>. In this example, because the “P−2^{M-1}”¹th bit TD“M−1”<P−2^{M-1}−1> of the first transfer data TD“M−1”<N:0> is “1”, an OR gate may be selected as the logic gate L1(P) according to the step 560 of FIG. 16. The OR gate that is disposed at the “P”^{th} bit position BP(P) may perform an OR operation on the “P”^{th} bit TD“M−1”<P−1> and the “P−2^{M-1}”^{th} bit TD“M−1”<P−2^{M-1}−1> of the “M−1”^{th} transfer data TD“M−1”<N:0> and output a result of the OR operation result, that is, “1” as a “P”^{th} bit TD“M”<P−1> of the “M”^{th} transfer data TD“M”<N:1>.

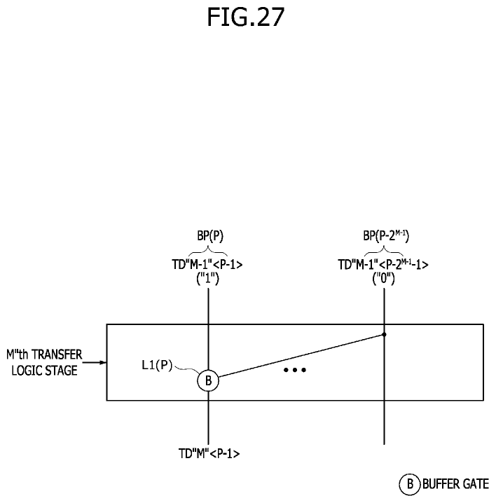

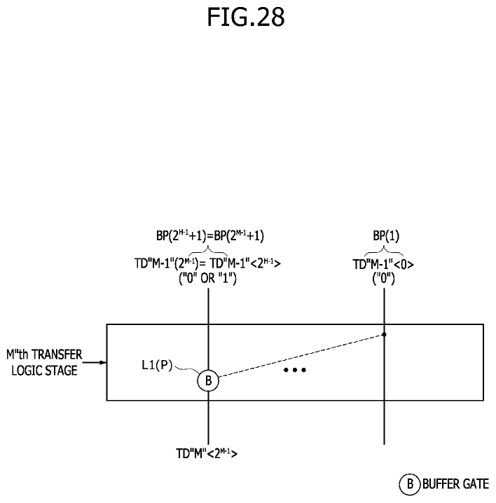

Next, as shown in FIG. 27, the “P”^{th} bit TD“M−1”<P−1> of the “M−1”^{th} transfer data TD“M−1”<N:0> is “1” and the “P−2^{M-1}”^{th} bit TD“M−1”<P−2^{M-1}−1> is “0”, a buffer gate may be selected as the logic gate L1(P) according to the step 570 of FIG. 16. The buffer gate that is disposed at the “P”^{th} bit position BP(P) may output the “P”^{th} bit TD“M−1”<P−1> of the “M−1”^{th} transfer data TD“M−1”<N:0>, that is, “1” as the “P”^{th} bit TD“M”<P−1> of the “M”^{th} transfer data TD“M”<N:0>. Next, as shown in FIG. 28, when the target bit position is the “2^{M-1}+1”^{th} bit position BP(2^{M-1}+1) corresponding to the “2^{H-1}+1”^{th} bit position BP(2^{H-1}+1), the buffer gate according to the step 520 of FIG. 16 may be selected as the logic gate L1(P) regardless of the “2^{H-1}+1”^{th} bit TD“M−1”<2^{H-1}−1> of the “M−1^{th} transfer data TD“M−1”<N:0>, that is, the “2^{M-1}+1”^{th} bit TD“M−1”<2^{M-1}>. If the buffer gate B according to the step 520 of FIG. 16 is selected, connection between the buffer gate B and the first bit position BP(1) may be removed as indicated by the dotted line in FIG. 28. The buffer gate B that is disposed at the “2^{M-1}+1”^{th} bit position BP(2^{M-1}+1) may output the “2^{M-1}+1”^{th} bit TD“M−1”<2^{M-1}> of the “M−1”^{th} transfer data TD“M−1”<N:0> as a “2^{M-1}+1”^{th} bit TD“M”<2^{M-1}> of the “M”^{th} transfer data TD“M”<N:0>.

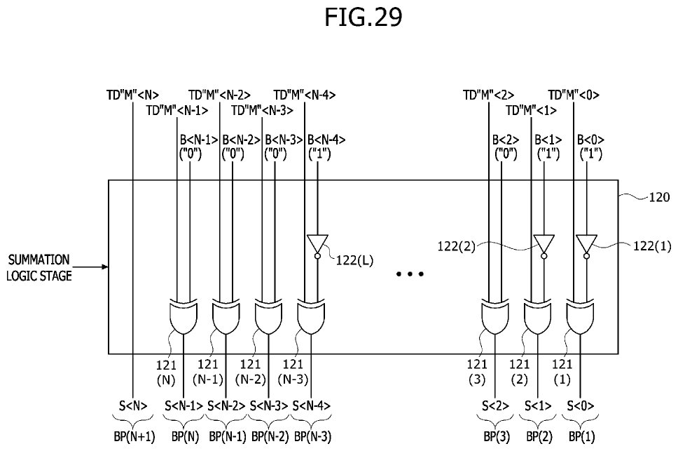

FIG. 29 is a diagram illustrating a method of configuring an summation logic stage in a method of designing a fixed binary adder 100 according to an example of the present disclosure. Referring to FIG. 29, “N+1” bit positions BP(N+1)-BP(1) may be allocated to the summation logic stage so as to respectively correspond to bits of the “N+1”-bit “M”^{th} transfer data TD“M”<N:0> transmitted from an “M”^{th} transfer logic sage 110(M). In addition, each of the “N+1” bit positions BP(N+1)-BP(1) of the summation logic stage 120 may correspond to each bit of the output data S<N:0>. The “N+1”^{th} bit TD“M”<N> of the “M”^{th} transfer data TD“M”<N:0> from the “M”^{th} transfer logic sage 110(M) may be transferred to the “N+1”^{th} bit position BP(N+1) of the summation logic stage 120, and an “N+1”^{th} bit S<N> of the output data S<N:0> having the same value as the input bit may be output.

The logic circuits (LC“N−1”-LC0 of FIG. 15) may be arranged at the “N”^{th} to first bit positions BP(N)-BP(1) of the summation logic stage 120. To this end, first, “N” XOR gates 121(N)-121(N−3), . . . , 121(3)-121(1) may be arranged at the “N”^{th} to first bit positions BP(N)-BP(1) of the summation logic stage 120. The “N”^{th} to first bits TD“M”<N−1:0> of the “M”^{th} transfer data TD“M”<N:0> may be input through an input terminal of each of the “N” XOR gates 121(N)-121(N−3), . . . , 121(3)-121(1).

Next, the “N” XOR gates 121(N)-121(N−3), . . . , 121(3)-121(1) may be classified into a first group and a second group. The process of classifying the XOR gates 121(N)-121(N−3), . . . , 121(3)-121(1) into the first group and the second group may be performed according to whether each bit of a first operand B<N−1:0> is “0” or “1”. As shown in the FIG. 29, each of the “N”^{th} to “N−2”^{th} and third bits B<N−1:N−3> and B<2> of the first operand B<N−1:0> corresponding to the “N”^{th} to “N−2”^{th} and third bit positions BP(N)-BP(N−2) and BP(3) of the first operand B<N−1:0> is “0”, and accordingly, the XOR gates 121(N)-121(N−2) and 121(3) of the “N”^{th} to “N−2”^{th} and third bit positions BP(N)-BP(N−2) and BP(3) may be classified into the first group. On the other hand, each of the “N−3”^{th}, second, and first bits B<N−4>, and B<1:0> of the first operand B<N−1:0> at the “N−3”^{th}, second, and first bit positions BP(N−3), BP(2), and BP(1) of the first operand B<N−1:0> is “1”, and accordingly, the XOR gates 121(N−3), 121(2), and 121(1) at the “N−3”^{th}, second, and first bit positions BP(N−3), BP(2), and BP(1) may be classified into the second group.

The “N”^{th} to “N−2”^{th} and third bits B<N−1:N−3> and B<2> of the first operand B<N:0> transmitted to the “N”^{th} to “N−2”^{th} and third bit positions BP(N)-BP(N−2) and BP(3) may be input to another input terminals of the XOR gates 121(N)-121(N−2), and 121(3) of the first group. In addition, NOT gates 122(L), 122(2), and 122(1) may be arranged to be connected to another input terminals of the XOR gates 121(N−3), 121(2), and 121(1) of the second group. The “N−3”^{th}, second, and first bits B<N−4>, and B<1:0> of the first operand B<N−1:0> may be input to input terminals of the NOT gates 122(L), 122(2), and 122(1).

The other input terminal of two input terminals of each of the XOR gates 121(N)-121(N−3), . . . , 121(3)-121(1) may be directly coupled to the other input line of the input line pairs to which the second operand A<N−1:0> is transmitted or coupled through a NOT gate. Hereinafter, the XOR gates in which the other input terminal of the two input terminals is directly coupled to the other input line of the input line pairs to which the second operand A<N−1:0> is transmitted may be classified into a first group and the XOR gates coupled through the NOT gate will be classified into a second group. In this case, the XOR gates of the first group may receive each bit of the second operand A<N−1:0> through the second input terminal. As shown in the drawings, the XOR gates 121(N)-121(N−2) that are disposed at the “N”^{th} to “N−2”^{th} bit positions BP(N)-BP(N−2) and the XOR gate 121(3) that is disposed at the third bit position BP(3) may belong to the first group. On the other hand, the XOR gates 121(N−3), 121(2), and 121(1) that are disposed at the “N−3”^{th}, second, and first bit positions BP(N−3), BP(2), and BP(1) may belong to the second group.

Whether the XOR gates 121(N)-121(N−3), . . . , 121(3)-121(1) belong to the first group or the second group may be determined according to the first operand. For example, when the “N”^{th} to first bit positions BP(N)-BP(1) respectively correspond to bits of the first operand, the XOR gates of the first group may be disposed at the bit positions corresponding to bits having a value of “0” in the binary stream of the first operand. On the other hand, the XOR gate of the second group may be disposed at bit positions respectively corresponding to bits having a value of “1” in the binary stream of the first operand. As shown in the drawing, the fact that the XOR gates 121(N)-121(N−2), and 121(3) are arranged at the “N”^{th} to “N−2”^{th} and third bit positions BP(N)-BP(N−2), and BP(3) may represent that the “N”^{th} to “N−2”^{th} and third bits of the first operand are “0”. In addition, the fact that the XOR gates 121(N−3), 121(2), and 121(1) are arranged at the “N−3”^{th}, second, and first bit positions BP(N−3), BP(2), and BP(1) may represent that the “N−3”^{th}, second, and first bits of the first operand are “1”. In other words, the fact that the summation logic stage 120 includes “L” NOT gates 122(L)-122L1) may represent that there are all “L” bits with a value of “1” in the first operand of the fixed binary adder 100.

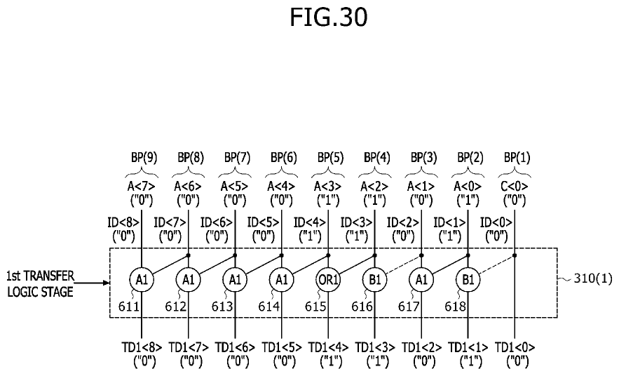

FIGS. 30 to 33 are diagrams illustrating a method of designing the “+13” fixed binary adder 300 of FIG. 9 according to an embodiment of the present disclosure. In this embodiment, because N is 8 and M is 3, the number of transfer logic stages may be set to three. And “H” has values of 1, 2, and 3 in the first to third transfer logic stages, respectively. Each of the first to third transfer logic stages may have “N+1” bit positions, that is, 9 bit positions BP(9)-BP(1). Referring to FIG. 30, each of the bit positions BP(9)-BP(1) may correspond to each of bits of 9-bit input data ID<8:0>, that is, 8-bit first operand B<N−1:0> and 1-bit carry-in data C<0>. Since the first operand B<N−1:0> of the “+13” fixed binary adder 300 is “0000 1101” and the carry-in data C<0> is “0”, the input data ID<8:0>“0 0001 1010” may be input to the first transfer logic stage 310(1) through the nine bit positions BP(9)-BP(1).

In order to arrange the logic gates in the first transfer logic stage 310(1), the upper and lower bits of the input data ID<8:0> may be compared. Specifically, a buffer gate 618 may be disposed at the “2^{H-1}+1”^{th} bit position, that is, the second bit position BP(2). Since the ninth bit ID<8> of the input data ID<8:0> is “0”, an AND gate 611 may be disposed at the ninth bit position BP(9). Since the eighth bit ID<7> of the input data ID<8:0> is also “0”, an AND gate 612 may be disposed at the eighth bit position BP(8). Since the seventh bit ID<6> of the input data ID<8:0> is also “0”, an AND gate 613 may be disposed at the seventh bit position BP(7). Since the sixth bit ID<5> of the input data ID<8:0> is also “0”, an AND gate 614 may be disposed at the sixth bit position BP(6). Since the fifth and fourth bits ID<4:3> of the input data ID<8:0> are both “1”, an OR gate 615 may be disposed at the fifth bit position BP(5). Since the fourth and third bits ID<3:2> of the input data ID<8:0> are “1” and “0”, respectively, a buffer gate 616 may be disposed at the fourth bit position BP(4). Since the third bit ID<2> of the input data ID<8:0> is “0”, an AND gate 617 may be disposed at the third bit position BP(3).

When the logic gates are disposed at the ninth to second bit positions BP(9)-BP(2) of the first transfer logic stage 310(1), the first transfer data TD1<8:0> may be extracted. As a result of an AND operation on the ninth bit ID<8>“0” and the eighth bit ID<7>“0” of the input data ID<8:0>, “0” may be output as the ninth bit TD1<8> of the first transfer data TD1<8:0> from the AND gate 611 of the ninth bit position BP(9). As a result of an AND operation on the eighth bit ID<7>“0” and the seventh bit ID<6>“0” of the input data ID<8:0>, “0” may be output as the eighth bit TD1<7> of the first transfer data TD1<8:0> from the AND gate 612 of the eighth bit position BP(8). As a result of an AND operation on the seventh bit ID<6>“0” and the sixth bit ID<5>“0” of the input data ID<8:0>, “0” may be output as the seventh bit TD1<6> of the first transfer data TD1<8:0> from the AND gate 613 of the seventh bit position BP(7). As a result of an AND operation on the sixth bit ID<5>“0” and the fifth bit ID<4>“1” of the input data ID<8:0>, “0” may be output as the sixth bit TD1<5> of the first transfer data TD1<8:0> from the AND gate 614 of the sixth bit position BP(6).

As a result of an OR operation on the fifth bit ID<4>“1” and the fourth bit ID<3>“1” of the input data ID<8:0>, “1” may be output as the fifth bit TD1<4> of the first transfer data TD1<8:0> from the AND gate 615 of the fifth bit position BP(5). The fourth bit ID<3>“1” of the input data ID<8:0> may be output as the fourth bit TD1<3> of the first transfer data TD1<8:0> from the buffer gate 616 of the fourth bit position BP(4). As a result of an AND operation on the third bit ID<2>“0” and the second bit ID<1>“1” of the input data ID<8:0>, “0” may be output as the third bit TD1<2> of the first transfer data TD1<8:0> from the AND gate 617 of the third bit position BP(3). The second bit ID<1>“1” of the input data ID<8:0> may be output as the second bit TD1<1> of the first transfer data TD1<8:0> from the buffer gate 618 of the second bit position BP(2). The first bit ID<0> of the input data ID<8:0> may become the first bit TD1<0> of the first transfer data TD1<8:0>. As such, the first transfer logic stage 310(1) may output “0 0001 1010” as the first transfer data TD1<8:0> at the ninth to first bit positions BP(9)-BP(1).

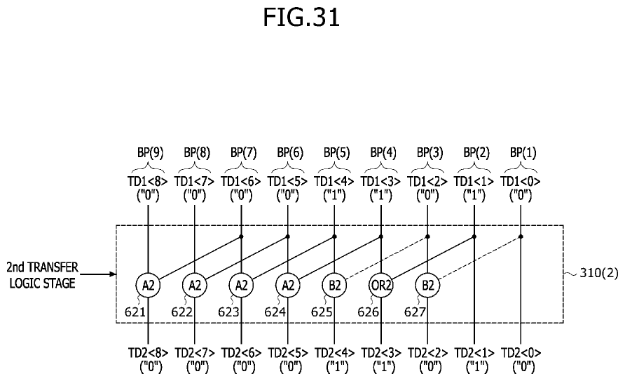

Referring to FIG. 31, in order to arrange the logic gates in the second transfer logic stage 310(2), the upper and lower bits of the first transfer data TD1<8:0> may be compared. Specifically, a buffer gate 627 may be disposed at the “2^{H-1}+”^{th} bit position, that is, the third bit position BP(3). Since the ninth bit TD1<8> of the first transfer data TD1<8:0> is “0”, an AND gate 621 may be disposed at the ninth bit position BP(9). Since the eighth bit TD1<7> of the first transfer data TD1<8:0> is also “0”, an AND gate 622 may be disposed at the eighth bit position BP(8). Since the seventh bit TD1<6> of the first transfer data TD1<8:0> is also “0”, an AND gate 623 may be disposed at the seventh bit position BP(7). Since the sixth bit TD1<5> of the first transfer data TD1<8:0> is also “0”, an AND gate 624 may be disposed at the sixth bit position BP(6). Since the fifth and third bits TD1<4> and TD1<3> of the of the first transfer data TD1<8:0> are “1” and “0”, respectively, a buffer gate 625 may be disposed at the fifth bit position BP(5). Since the fourth and second bits TD1<3> and TD1<1> of the first transfer data TD1<8:0> are all “1”, an OR gate 626 may be disposed at the fourth bit position BP(4).

When the logic gate are disposed at the ninth to second bit positions BP(9)-BP(2) of the second transfer logic stage 310(2), the second transfer data TD2<8:0> may be extracted. As a result of an AND operation on the ninth bit TD1<8>“0” and the eighth bit TD1<7>“0” of the first transfer data TD1<8:0>, “0” may be output as the ninth bit TD2<8> of the second transfer data TD2<8:0> from the AND gate 62 of the ninth bit position BP(9). As a result of an AND operation on the eighth bit TD1<7>“0” and the seventh bit TD1<6>“0” of the first transfer data TD1<8:0>, “0” may be output as the eighth bit TD2<7> of the second transfer data TD2<8:0> from the AND gate 622 of the eighth bit position BP(8). As a result of an AND operation on the seventh bit TD1<6>“0” and the fifth bit TD1<5>“0” of the first transfer data TD1<8:0>, “0” may be output as the seventh bit TD2<6> of the second transfer data TD2<8:0> from the AND gate 623 of the seventh bit position BP(7).

As a result of an AND operation on the sixth bit TD1<5>“0” and the fourth bit TD1<4>“1” of the first transfer data TD1<8:0>, “0” may be output as the sixth bit TD2<5> of the second transfer data TD2<8:0> from the AND gate 624 of the sixth bit position BP(6). The fifth bit TD1<4>“1” of the first transfer data TD1<8:0> may be output as the fifth bit TD2<4> of the second transfer data TD2<8:0> from the buffer gate 625 of the fifth bit position BP(5). As a result of an OR operation on the fourth bit TD1<3>“1” and the second bit TD1<1>“1” of the first transfer data TD1<8:0>, “1” may be output as the fourth bit TD2<3> of the second transfer data TD2<8:0> from the OR gate 626 of the fourth bit position BP(4). The third bit TD1<2>“0” of the first transfer data TD1<8:0> may be output as the third bit TD2<2> of the second transfer data TD2<8:0> from the buffer gate 627 of the third bit position BP(3). The second bit TD1<1>“1” and the first bit TD1<0>“0” of the first transfer data TD1<8:0> may become the second bit TD2<1> and first bit TD2<0> of the second transfer data TD2<8:0>. As such, the second transfer logic stage 310(2) may output “0 0001 1010” as the second transfer data TD2<8:0> at the ninth to first bit positions BP(9)-BP(1).

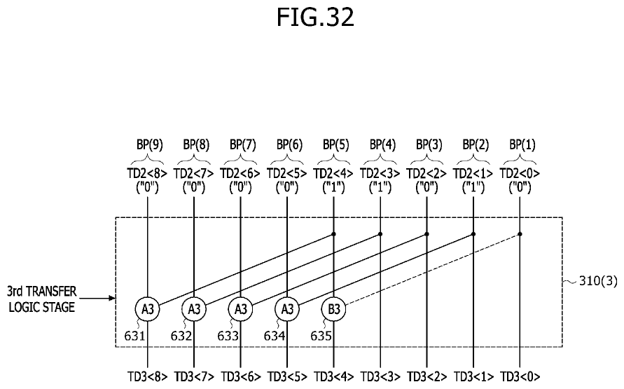

Referring to FIG. 32, in order to arrange logic gates in the third transfer logic stage 310(3), the upper and lower bits of the first transfer data TD1<8:0> may be compared. Specifically, a buffer gate 635 may be disposed at the “2^{H-1}+”^{th} bit position, that is, the fifth bit position BP(5). Since the ninth bit TD2<8> of the second transfer data TD2<8:0> is “0”, an AND gate 621 may be disposed at the ninth bit position BP(9). Since the ninth bit TD2<8> of the second transfer data TD2<8:0> is “0”, an AND gate 631 may be disposed at the ninth bit position BP(9). Since the eighth bit TD2<7> of the second transfer data TD2<8:0> is also “0”, an AND gate 632 may be disposed at the eighth bit position BP(8). Since the seventh bit TD2<6> of the second transfer data TD2<8:0> is also “0”, an AND gate 633 may be disposed at the seventh bit position BP(7). Since the sixth bit TD2<5> of the second transfer data TD2<8:0> is also “0”, an AND gate 634 may be disposed at the sixth bit position BP(6). Since the third transfer logic stage 310(3) is the last transfer logic stage, it is not necessary to extract third transfer data TD3<8:0> from the third transfer logic stage 310(3).

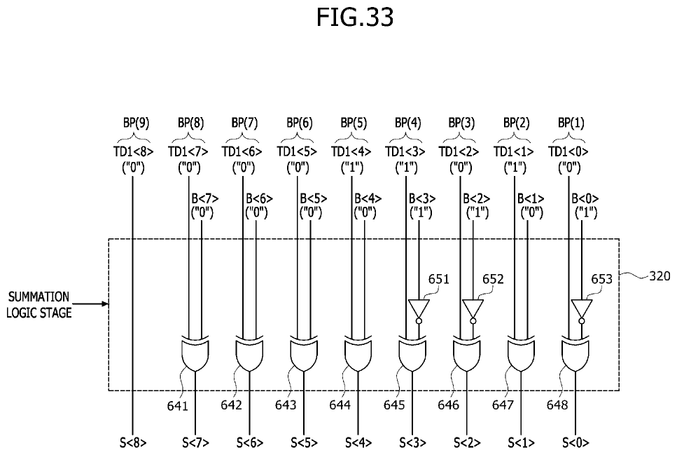

Referring to FIG. 33, nine bit positions BP(9)-BP(1) may be allocated in the summation logic stage 320 so as to correspond to each bit of the third transfer data TD3<8:0> transmitted from the third transfer logic stage 310(3). In addition, each of the nine bit positions BP(9)-BP(1) of the summation logic stage 320 may correspond to each bit of the output data S<8:0>. The ninth bit TD3<8> of the third transfer data TD3<8:0> may be transmitted to the ninth bit position BP(9) of the summation logic stage 320, and the ninth bit S<8> of the output data S<8:0> having the same value as the input bit may be output.

Logic circuits may be arranged at the eighth to first bit positions BP(8)-BP(1) of the summation logic stage 320. To this end, first, eight XOR gates 641-648 may be arranged at the eighth to first bit positions BP(8)-BP(1) of the summation logic stage 320. The eighth to first bits TD3<7:0> of the third transfer data TD3<8:0> may be input through one input terminal of each of the eight XOR gates 641-648. Next, the eight XOR gates 641-648 may be classified into a first group and a second group. The eighth to fifth and second bits B<7:4> and B<1> of the first operand B<7:0> corresponding to the eighth to fifth and second bit positions BP(8)-BP(5) and BP(2) are “0”, and accordingly, the XOR gates 641-644 and 647 of the eighth to fifth and second bit positions BP(8)-BP(5) and BP(2) may be classified into the first group. On the other hand, the fourth, third, and first bits B<3:2> and B<0> of the first operand B<7:0> corresponding to the fourth, third, and first bit positions BP(4), BP(3), and BP(1) of the first operand B<7:0> are “1”, and accordingly, the XOR gates 645, 646, and 648 at the fourth, third, and first bit positions BP(4), BP(3), and BP(1) may be classified into the second group.

The eighth to fifth and second bits B<7:4> and B<1> of the first operand B<7:0> transmitted to the eighth to fifth and second bit positions BP(8)-BP(5) and BP(2) may be input to the another input terminals of the XOR gates 645, 646, and 648 of the first group, respectively. NOT gates 651, 652, and 653 may be disposed to be connected to the other input terminals of the XOR gates 651, 652, and 653 of the second group. The fourth, third, and first bits B<3:2> and B<0> of the first operand B<7:0> may be input to input terminals of the NOT gates 651, 652, and 653.

According to various embodiments, when performing an “N”-bit addition operation, the “N”-bit addition operation may be implemented with “log₂^{M}” transfer logic stages and one summation logic stage, so that the “N”-bit addition operation may be implemented in a small area and also may provide the advantage of providing fast operation speed compared to the general parallel prefix adder in which operations for a carry generation function (Gi) and a carry propagation function (Pi) should be preceded.

A limited number of possible embodiments for the present teachings have been presented above for illustrative purposes. Those of ordinary skill in the art will appreciate that various modifications, additions, and substitutions are possible. While this patent document contains many specifics, these should not be construed as limitations on the scope of the present teachings or of what may be claimed, but rather as descriptions of features that may be specific to particular embodiments. Certain features that are described in this patent document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

What is claimed is:

1. A fixed binary adder for generating “N+1”-bit output data (N=2^{M}, M is a natural number) by adding an “N”-bit second operand to a first operand having an “N”-bit fixed value, the fixed binary adder comprising:
a plurality of transfer logic stages, each of the plurality of transfer logic stages being configured with at least one logic gate; and
a summation logic stage configured to generate the “N+1”-bit output data by using the “N”-bit second operand and transfer data that is generated through the plurality of transfer logic stages,
wherein the logic gate is configured with one of an AND gate, an OR gate, and a buffer gate.

2. The fixed binary adder of claim 1, further comprising:
a first input terminal and a second input terminal to which “N+1”-bit input data is input; and
an output terminal from which the “N+1”-bit output data is output,
wherein the “N+1”-bit input data is configured with the “N”-bit second operand and 1-bit carry data.

3. The fixed binary adder of claim 2,
wherein the 1-bit carry data constitutes a least significant bit of the “N+1”-bit input data, and
wherein the “N”-bit second operand constitutes an “N+1”^{th} bit to a second bit of the “N+1”-bit input data.

4. The fixed binary adder of claim 3, wherein the 1-bit carry data has a fixed binary value of “0”.

5. The fixed binary adder of claim 3, wherein each of the plurality of transfer logic stages and summation logic stage has “N+1” bit positions corresponding to each of the “N+1”-bit input data.

6. The fixed binary adder of claim 5, wherein the number of the plurality of transfer logic stages is set to “M”.

7. The fixed binary adder of claim 5, wherein a first transfer logic stage, among the plurality of transfer logic stages, is configured to receive the “N+1”-bit input data and output “N+1”-bit first transfer data.

8. The fixed binary adder of claim 7,
wherein one of the AND gate, the OR gate, and the buffer gate is disposed as the logic gate at a “P”^{th} bit position (“P” is N+1, N, . . . , 3), among the “N+1” bit positions of the first transfer logic stage,
wherein the buffer gate is disposed as the logic gate at a second bit position of the first transfer logic stage, and
wherein a logic gate is not disposed at a first bit position of the first transfer logic stage.

9. The fixed binary adder of claim 8, wherein the AND gate or the OR gate that is disposed at the “P”^{th} bit position of the first transfer logic stage is configured to receive a “P”^{th} bit and a “P−1”^{th} bit of the “N+1”-bit input data.

10. The fixed binary adder of claim 9, wherein the AND gate disposed at the “P”^{th} bit position of the first transfer logic stage is configured to perform an AND operation on the “P”^{th} bit and the “P−1”^{th} bit of the “N+1”-bit input data and configured to output a result of the AND operation as a “P”^{th} bit of the “N+1”-bit first transfer data.

11. The fixed binary adder of claim 9, wherein the OR gate disposed at the “P”^{th} bit position of the first transfer logic stage is configured to perform an OR operation on the “P”^{th} bit and the “P−1”^{th} bit of the “N+1”-bit input data and configured to output a result of the OR operation as the “P”^{th} bit of the “N+1”-bit first transfer data.

12. The fixed binary adder of claim 8, wherein the buffer gate disposed at the “P”^{th} bit position of the first transfer logic stage is configured to receive the “P”^{th} bit of the “N+1”-bit input data.

13. The fixed binary adder of claim 12, wherein the buffer gate disposed at the “P”^{th} bit position of the first transfer logic stage is configured to output the “P”^{th} bit of the “N+1”-bit input data as the “P”^{th} bit of the “N+1”-bit first transfer data.

14. The fixed binary adder of claim 8, wherein the buffer gate disposed at the second bit position of the first transfer logic stage is configured to output a second bit of the “N+1”-bit input data as a second bit of the “N+1”-bit first transfer data.

15. The fixed binary adder of claim 8, wherein the first transfer logic stage is configured such that, at the first bit position of the first transfer logic stage, the first bit of the “N+1”-bit input data is output as the first bit of the “N+1”-bit first transfer data.

16. The fixed binary adder of claim 5, wherein a “K”^{th} transfer logic stage (“K” is a natural number greater than or equal to 2 and less than or equal to “M”), among the plurality of transfer logic stages, is configured to receive “N+1”-bit “K−1”^{th} transfer data that is output from a “K−1”^{th} transfer logic stage and configured to output “N+1”-bit “K”^{th} transfer data.

17. The fixed binary adder of claim 16,
wherein one of the AND gate, the OR gate, and the buffer gate is disposed as the logic gate at a “P”^{th} bit position (“P” is N+1, N, . . . , 2K−1+2), among “N+1” bit positions of the “K”^{th} transfer logic stage, wherein the buffer gate is disposed as the logic gate at a “2^{K-1}+1”^{th} bit position of the “K”^{th} transfer logic stage, and wherein a logic gate is not disposed at “2^{K-1}”^{th} to first bit positions of the “K”^{th} transfer logic stage.

18. The fixed binary adder of claim 17, wherein the AND gate or the OR gate that is disposed at the “P”^{th} bit position of the “K”^{th} transfer logic stage is configured to receive a “P”^{th} bit and a “P−2^{K-1}”^{th} bit of the “N+1”-bit “K−1”^{th} transfer data.

19. The fixed binary adder of claim 18, wherein the AND gate disposed at the “P”^{th} bit position of the “K”^{th} transfer logic stage is configured to perform an AND operation on the “P”^{th} bit and the “P−2^{K-1}”^{th} bit of the “N+1”-bit “K−1”^{th} transfer data and configured to output a result of the AND operation as a “P”^{th} bit of the “N+1”-bit “K”^{th} transfer data.

20. The fixed binary adder of claim 18, wherein the OR gate disposed at the “P”^{th} bit position of the “K”^{th} transfer logic stage is configured to perform an OR operation on the “P”^{th} bit and the “P−2^{K-1}”^{th} bit of the “N+1”-bit “K−1”^{th} transfer data and configured to output a result of the OR operation as the “P”^{th} bit of the “N+1”-bit “K”^{th} transfer data.

21. The fixed binary adder of claim 17, wherein the buffer gate disposed at a “2^{K-1}+1”^{th} bit position of the “K”^{th} transfer logic stage is configured to receive the “P”^{th} bit of the “N+1”-bit “K−1”^{th} transfer data.

22. The fixed binary adder of claim 21, wherein the buffer gate disposed at the “P”^{th} bit position of the “K”^{th} transfer logic stage is configured to output the “P”^{th} bit of the “N+1”-bit “K−1”^{th} transfer data as the “P”^{th} bit of the “N+1”-bit “K”^{th} transfer data.

23. The fixed binary adder of claim 17, wherein the buffer gate disposed at the “2^{K-1}+1”^{th} bit position of the “K”^{th} transfer logic stage is configured to output a “2^{K-1}+1”^{th} bit of the “N+1”-bit “K−1”^{th} transfer data as a “2^{K-1}+1”^{th} bit of the “N+1”-bit “K”^{th} transfer data.

24. The fixed binary adder of claim 17, wherein the “K”^{th} transfer logic stage is configured such that “2^{K-1}”^{th} to first bits of the “N+1”-bit “K−1”^{th} transfer data is output as “2^{K-1}”^{th} to first bits of the “N+1”-bit “K”^{th} transfer data at the “2^{K-1}”^{th} to first bit positions, respectively.

25. The fixed binary adder of claim 5,
wherein the “M”^{th} transfer logic stage, among the plurality of transfer logic stages, is configured to output “N+1”-bit “M”^{th} transfer data, and
wherein the summation logic stage is configured to receive the “N+1”-bit “M”^{th} transfer data and the “N”-bit second operand and configured to output the “N+1”-bit output data.

26. The fixed binary adder of claim 25, wherein the summation logic stage is configured to output an “N+1”^{th} bit of the “N+1”-bit “M”^{th} transfer data as an “N+1”^{th} bit of the “N+1”-bit output data at the “N+1”^{th} bit position.

27. The fixed binary adder of claim 26,
wherein the summation logic stage includes “N” logic circuits disposed at the “N”^{th} to first bit positions, and
wherein each of the “N” logic circuits is configured with XOR gates of a first group or configured with XOR gates of a second group and a NOT gate.

28. The fixed binary adder of claim 27, wherein the XOR gate of the first group disposed at a “P”^{th} bit position (“P” is N, . . . , 1) of the summation logic stage is configured to receive a “P”^{th} bit of the “N+1”-bit “M”^{th} transfer data through a first input terminal and configured to receive a “P”^{th} bit of the “N”-bit second operand through a second input terminal.

29. The fixed binary adder of claim 28, wherein the XOR gate of the first group disposed at the “P”^{th} (“P” is N, . . . , 1) bit position of the summation logic stage is configured to perform an XOR operation on the “P”^{th} bit of the “N+1”-bit “M”^{th} transfer data and the “P”^{th} bit of the “N”-bit second operand and configured to output a result of the XOR operation as a “P”^{th} bit of the “N+1”-bit output data.

30. The fixed binary adder of claim 27,
wherein the XOR gate of the second group disposed at the “P”^{th} (“P” is N, . . . , 1) bit position of the summation logic stage includes a first input terminal that receives the “P”^{th} bit of the “N+1”-bit “M”^{th} transfer data and a second input terminal that is coupled to an output terminal of the NOT gate, and
wherein the NOT gate is configured to receive the “P”^{th} bit of the “N”-bit second operand.

31. The fixed binary adder of claim 30, wherein the XOR gate of the second group disposed at the “P”^{th} (“P” is N, . . . , 1) bit position of the summation logic stage is configured to perform an XOR operation on the “P”^{th} bit of the “N+1”-bit “M”^{th} transfer data and an inverted bit of the “P”^{th} bit of the “N”-bit second operand and configured to output a result of the XOR operation as the “P”^{th} bit of the “N+1”-bit output data.
